(19) United States
(12) Patent Application Publication
(10) Pub. No.: US 2024/0420875 A1
(43) Pub. Date: Dec. 19, 2024

(54) Processes, Systems and Devices for Metal-Filling of Open HTS Channels

(71) Applicants: Massachusetts Institute of Technology, Cambridge, MA (US); Commonwealth Fusion Systems LLC, Devens, MA (US)

(72) Inventors: Amanda HUBBARD, Bedford, MA (US); Brian LABOMBARD, Belmont, MA (US); Richard MURRAY, Derry, NH (US); James IRBY, Natick, MA (US); Rui VIEIRA, Billerica, MA (US); William BECK, Alton Bay, NH (US); Thomas TOLAND, Waltham, MA (US); Vincent FRY, Durham, NC (US); Shane SCHWEIGER, Ekalaka, MT (US); Amelia WATTERSON, Cambridge, MA (US); Sarah CHAMBERLAIN, Revere, MA (US); Jose ESTRADA, Lawrence, MA (US); Theodore MOURATIDIS, Boston, MA (US); Kenneth STEVENS, Wayland, MA (US)

(73) Assignees: Massachusetts Institute of Technology, Cambridge, MA (US); Commonwealth Fusion Systems LLC, Devens, MA (US)

(21) Appl. No.: 18/704,182

(22) PCT Filed: Nov. 15, 2022
(86) PCT No.: PCT/US2022/049876

§ 371 Date: Apr. 24, 2024

Related U.S. Application Data
(60) Provisional application No. 63/279,443, filed on Nov. 15, 2021.

(51) Int. Cl. H01F 6/06; H01F 41/04

(52) U.S. Cl. CPC H01F 6/06; H01F 41/048

(57) ABSTRACT

Described are concepts, systems, structures and techniques for metal filling an open channel (12) in a baseplate (19). In embodiments, metal filling of an open baseplate channel is achieved using vacuum pressure impregnation (VPI). In embodiments, a compression plate (14a) is disposed over an open baseplate channel (12) to be filled with a molten metal. In embodiments, gaskets (97) are disposed between the compression plate (14a) and a surface of the baseplate (10) proximate the baseplate channel (12). In embodiments, a channel cap (26) is disposed over the open channel. In embodiments, the channel cap (26) has a solder flow channel (29, 32) provided in a surface thereof. In the embodiments, the solder flow channel (29, 32) has a meandering shape. In embodiments, a solder flow channel (29, 32′) is provided in the compression plate (14a) and/or the baseplate (10). The concepts, systems, structures and techniques described herein are suitable for use in the fabrication of a no-insulation, no-twist (NINT) high temperature superconducting (HTS) magnet.

### BACKGROUND

There is a class of high temperature superconducting (HTS) magnets referred to as no-insulation, no-twist (NINT) magnets in which HTS material in the form of HTS tapes are inserted in channels of a baseplate made of a resistive medium such as steel, without insulation between the HTS tape.

### SUMMARY

In accordance with one aspect of the concepts described herein, it has been recognized that it is desirable to surround high temperature superconducting (HTS) material (e.g. in the form of an HTS tape) disposed in an open channel of a baseplate with a conductive metal. To that end, described herein are concepts, systems, structures and techniques for metal filling of an open channel in a baseplate.

Metal-filled HTS channels find use in the manufacture of no-insulation, no-twist (NINT) high temperature superconducting magnets in which an HTS material is disposed in channels of a baseplate made of a resistive medium such as steel. In embodiments in which channels of the baseplate are in a spiral configuration, no insulation exists between turns of the HTS material. In embodiments, the HTS material is provided in the form of an HTS tape (or a bundle or stack of HTS tapes) inserted or otherwise disposed in the channels of the baseplate without insulation between turns of the HTS material.

In embodiments, metal filling of open channels in a baseplate is achieved using vacuum pressure impregnation (VPI). In embodiments, a compression plate is disposed over an open channel to be filled with a molten metal. In embodiments, gaskets are disposed between surfaces of the compression plate and the baseplate.

In embodiments, a channel cap is disposed over the open channel. In embodiments, the channel cap itself has an open channel (also sometimes referred to herein as a solder channel) provided therein. In embodiments, the solder channel provided in the channel cap has a meandering shape.

In embodiments, the baseplate channels and/or the channel cap solder channel may comprise segmentation structures.

In accordance with one aspect of the concepts described herein, a method includes: (a) providing a baseplate having an open channel provided therein with a HTS material disposed in the channel; and (b) filling the open channel of the baseplate with a conductive metal using vacuum pressure impregnation.

With this particular arrangement, a method for depositing a conductive metal in contact with at least part of an HTS material (e.g., HTS tape) disposed in a baseplate channel is provided. In some cases, the conductive metal may partially or fully surround the HTS material. Fully or partially surrounding HTS tape disposed in a baseplate channel with a conductive metal provides a number of advantages including, but not limited to: increased mechanical stability (relative to a baseplate which does not have metal-filled channels); increased electrical conduction (relative to a baseplate which does not have metal-filled channels) which enables sharing of current between HTS tapes and also enables sharing of current between HTS tapes and a baseplate; and/or increased thermal conduction (relative to a baseplate which does not have metal-filled groves). Sharing of current between HTS tapes and between HTS tapes and a baseplate may be particularly important in NINT high temperature superconducting magnets in the event a critical current is approached and/or in the event of a tape defect. Increased thermal conduction provided by filling channels with metal aids in cooling of a magnet via channels in the base plate and aids in distributing heat in the event of a quench.

In embodiments, filling the open channel of a baseplate with a conductive metal using a VPI technique comprises the unordered acts of: cleaning the channel; disposing an HTS material in the channel; evacuating the channel; purging the channel with an inert gas; depositing flux into the channel to coat HTS disposed in the channel and the baseplate; draining any excess flux from the channel; heating the baseplate channel and metal to provide a molten metal; and flowing the molten metal into the baseplate channel.

In embodiments, the metal comprises an alloy. In embodiments, the metal to be flowed is a solder. In embodiments, the metal to be flowed is a tin-lead (PbSn) solder.

In embodiments, heating the baseplate channel comprises heating the baseplate channel to a temperature substantially at, or above a temperature at which the alloy to be deposited will melt and flowing a molten alloy into the baseplate channel.

It is recognized that use of a VPI technique has advantages for insertion of HTS material (e.g. HTS tape) in NINT baseplate channels, but it is also recognized that use of a VPI technique also adds challenges.

For example, in embodiments in which a baseplate includes multiple channels, the channels may be thermally coupled. Further still, the baseplate may have a thermal mass which is relatively high compared with a thermal mass of an HTS cable, for example. Thus, the time required to reach temperatures suitable to flow a molten metal in channels of a baseplate is typically greater than the time required to reach temperatures suitable to flow a molten metal in an HTS cable.

Since NINT channels may have HTS material disposed therein (e.g., one or more HTS tapes), when filling channels with a molten metal care it may be important to not exceed temperatures which may damage mechanical or electrical characteristics of the HTS material. Furthermore, it may be important to not exceed a combination of time and temperatures which may damage mechanical or electrical characteristics of an HTS material (i.e. exposure of the HTS material to a temperature over a given period of time).

The structures and processes used for metal filling of channels described herein do not substantially degrade either mechanical or electrical (e.g. superconducting) properties of HTS tape bundles. Thus, such structures and processes are suitable for use in NINT magnets having HTS tape bundles disposed in open channels of a baseplate.

In one embodiment, a method for filling NINT channels with a molten metal comprises flowing solder through a channel using both vacuum and pressure (a so-called “vacuum pressure impregnation technique” or “VPI technique”).

In embodiments, compression plates with gaskets are used to convert open channels in a baseplate into a vacuum sealed assembly, with single metal flow path. This enables a monotonic pressure gradient along the tape channel suitable for a VPI solder-filling process. In embodiments, compression plates with gaskets are used to convert open channels in a baseplate into a vacuum sealed assembly, multiple flow paths.

In embodiments, a channel cap having a channel specifically for solder flow. In embodiments, the channel in the channel cap is straight and may be centered. In embodiments, the channel in the channel cap is not straight and centered, but rather meanders from side to side (e.g. in an S shape).

In embodiments, a solder channel provided in a channel cap may comprise segmentation structures which prevent compression of a gap or space through which a molten metal (e.g. solder) may flow. In embodiments, a baseplate channel may comprise segmentation structures which facilitate the flow or a molten metal (e.g. solder) in the baseplate channels during a metal fill process.

The described structures and techniques enable the filling of channels in NINT magnets, or linear HTS channels, with solder or other molten metal.

The described structures and techniques are readily adaptable to a variety of different sizes and/or geometries of channels (linear, curved, spirals, others).

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principles of the concepts described herein. Like reference numerals designate corresponding parts throughout the different views. Furthermore, embodiments are illustrated by way of example and not limitation in the figures, in which:

FIG. 1 is an isometric view of a plate no-insulation, no-twist (NINT) suitable for use in forming a magnet having provided therein open channels disposed in a spiral arrangement;

FIG. 2 is a cross-sectional view of a portion of a vacuum pressure impregnation (VPI) plate assembly;

FIG. 3A is an isometric view of a VPI plate assembly including a plurality of stiffeners disposed on compression plates;

FIGS. 3B and 3C is cross-sectional view of a portion of a VPI plate assembly;

FIG. 4A is a cross-sectional view of a channel cap disposed over an open channel in a baseplate;

FIG. 4B is a cross-sectional view of a channel cap disposed over a channel in a baseplate with the channel cap having a solder flow channel;

FIG. 4C is an end view of a channel cap disposed over an open channel in a baseplate taken across lines 4D-4D;

FIG. 4D is a top view of a channel cap disposed over a channel in a baseplate with the channel cap having a solder flow channel;

FIG. 5 is an isometric view of a channel cap having a solder channel with a meandering shape;

FIG. 6A is a top view of a portion of a channel cap having a segmented solder channel;

FIG. 6B is a top view of an alternate embodiment of a channel cap having a segmented solder channel;

FIG. 7 is a flow diagram of an example VPI process for metal filling open channels in a baseplate;

FIG. 8 is a schematic diagram of an illustrative processing station for implementing a metal filling process which may be the same as or similar to the process described in conjunction with FIG. 7;

FIG. 9 is a bottom view of a VPI plate assembly comprising a bottom compression plate having a plurality of heaters disposed on a surface thereof;

FIGS. 10A-10G illustrate alternative unit cell arrangements for a solder channel and channel cap;

FIGS. 10H-10N illustrate alternative unit cell embodiments for a solder channel;

FIGS. 11A and 11B illustrate solder channel concepts that can be used to wet one or more edges of a copper cap during a VPI process;

FIGS. 12A-12C illustrate a solder bar method;

FIGS. 13A and 13B are isometric partial cross-sectional views of a double pancake;

FIG. 14 illustrates a baseplate having multiple Inputs/multiple outputs for solder flow;

FIG. 15A illustrates a baseplate having a single inlet and single outlet;

FIG. 15B illustrates a baseplate having a single inlet and a double outlet; and

FIG. 16 is a cross-sectional view of an inlet.

### DETAILED DESCRIPTION

It should be appreciated that to promote clarity in the description of the broad concepts, structures and techniques disclosed herein, the concepts, structures and techniques are sometimes described in the context of a no-insulation, no-twist (NINT) magnet having HTS tape disposed in open channels of a baseplate with the channels having a spiral shape. After reading the description provided herein, however, those of ordinary skill in the art will appreciate that the metal filling concepts, structures and techniques described herein can also be used with other channel geometries such as single, straight or curved HTS channels which may be used in device other than NINT magnets. For example, the described structures and methods are suitable for filling linear HTS channels with a molten metal including but not limited to solder.

It should also be appreciated that some embodiments described herein below may include a conductive “channel cover” or “channel cap” (e.g., as part of a NINT magnet design) while other embodiments may not include a channel cap. The metal filling technique described herein may be used to fill an open baseplate channel regardless of whether a channel cap is used.

It should also be appreciated that the processes, systems and devices described herein are also appropriate for use in metal-filling of channels in baseplates having shapes other than spiral shapes. In general, the processes, systems and devices described herein are suitable for use in in metal-filling of open channels having HTS material (e.g. one or more HTS tapes or tape bundles) provided therein (with an open channel in a baseplate having HTS material therein sometimes referred to herein as an “open HTS channel” or more simply an “HTS channel”).

It should also be appreciated that to promote clarity in the description of the concepts sought to be protected herein, reference is sometimes made herein to filling baseplate channels with solder or a particular type of solder. After reading the description provided herein, one of ordinary skill in the art will appreciate that any metal or alloy capable of being melted and flowing in baseplate channels may be used.

The processes, systems and devices described herein meet a number of challenges (both structural and process challenges) required to apply a vacuum pressure impregnation (VPI) metal filling technique to open HTS channels, and in particular to open HTS channels provided in plates (a/k/a baseplates).

Such challenges include but are not limited to: (1) sealing open HTS tape channels with a structure which allows a continuous, imposed pressure gradient along the channel. The sealing structure must be capable of both holding vacuum and sustaining pressures needed to achieve a flow of a molten metal (e.g., molten solder) which allows the HTS tape channels to be filled with the molten metal within a period of time which is short enough so that HTS tapes disposed in the channels mare not damaged while also allowing one or more inlets and outlets for solder flow; (2) assuring a sufficiently large, open channel for solder flow, again to fill in a short enough time so that HTS tapes are not exposed to relatively high temperatures for a long period of time; (3) heating to uniformly raise the temperature of the VPI plate assembly to the optimal temperature for solder flow, while reducing (and ideally minimizing) time-temperature and solder exposure of the HTS tape; (4) rapid cooling of the VPI plate assembly after solder flow, again to reduce (and ideally minimize) time-temperature and solder exposure of the HTS tape; (5) for large magnets, options to split channels with multiple inlets or outlets, and independent control of flow.

The concepts, systems, devices, techniques and features described herein meet (either collectively or individually) each of these challenges.

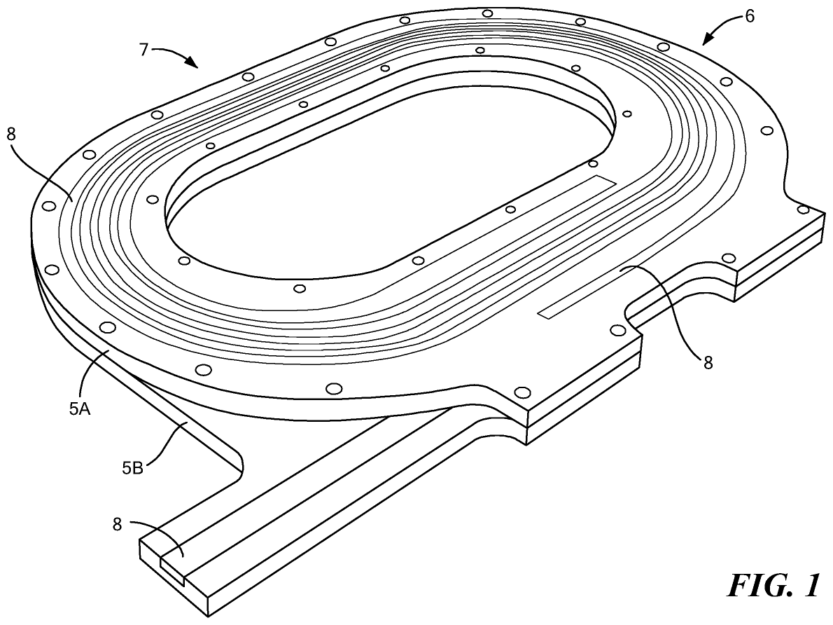

Referring now to FIG. 1, an illustrative baseplate 5A having channels 6 (or “grooves”) disposed therein. As will be described in detail below, in the example embodiment of FIG. 1, the HTS channels 6 have been filled with a molten metal 8. Techniques for filling open HTS channels with metal are described herein below. In the example embodiment, of FIG. 1, the channels 6 are provided having a spiral configuration 7 (i.e., a spiral shape or a spiral arrangement sometimes referred to as a racetrack configuration). A baseplate having a spiral-shaped groove is sometimes referred to as a spiral-grooved plate and is suitable for use in forming a spiral-grooved, NINT magnet. It should be understood the metal filling techniques described herein for filling one or more baseplate channels with metal are suitable for use with channels having any configuration-including but not limited to configurations other than spiral configurations. It should also be understood that although reference is made herein to filling channels having a substantially cross-sectional shape the metal filling techniques described herein may be used with channels having any cross-sectional shapes including any regular or irregular geometric cross-sectional shapes.

It should be noted the exemplary embodiment of FIG. 1 illustrates a pair of such baseplates 5A, 5B and baseplate 5B also has channels 6 filled with metal.

### Sealing and Separation of Channels

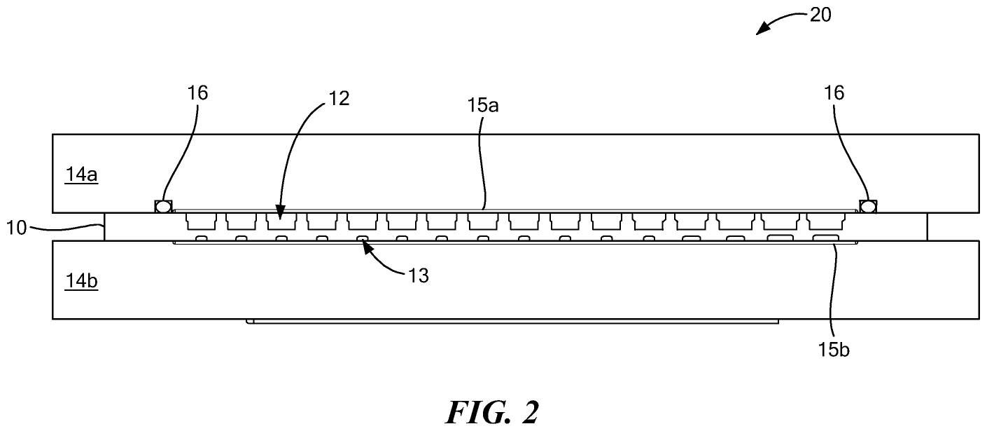

With reference to FIG. 2, shown is a portion of a baseplate 10 which may be the same as or similar to baseplate 5 in FIG. 1. Baseplate 10 has first and second opposing surfaces 10a, 10b with a plurality of channel regions 12 (or more simply “channels”) provided in surface 10a. Baseplate 10 may optionally include a plurality of channels 13 disposed in surface 10b. Thus, baseplate 12 is sometimes referred to herein as a “channelized baseplate” or more simply a “channelized plate.” Channels 13 are cooling channels (e.g., channels through which a cooling fluid or material may be disposed). The VPI process described herein keeps these channels free from solder.

Such a channelized baseplate may be suitable for use in a fusion magnet coil, for example. It should be appreciated that the channel regions may be part of a single continuous channel (e.g., such as the spiral shaped channel 7 provided in baseplate 5 of FIG. 1) or the channel regions may correspond to portions of two or more individual (or separate) channels. As can be seen in FIG. 2, channels 12 are not yet filled with metal. Thus, the baseplate channels are exposed or “open” on one side. Hence, the baseplate channels 12 are sometimes referred to as “open” baseplate channels or more simply as “open channels.”

It should be noted that, although not shown in FIG. 2, an HTS material (e.g. an HTS tape) may be disposed in some or all of the channels (or in some regions or all regions of a single baseplate channel). Such a baseplate with HTS tape disposed in channels thereof is suitable for use in a magnet coil.

As noted above, it can be advantageous to fill an open baseplate channel with a molten metal. This may be accomplished, for example, using a vacuum pressure impregnation (VPI) metal filling technique. To utilize VPI, however, it is necessary to turn an open channel into a closed channel suitable for VPI flow. In one embodiment, to utilize a VPI process requires disposing a compression plate 14a (also sometimes referred to herein as a “cover plate,” “first cover plate,” “top cover plate” or more simply a “top plate”) over the open baseplate channel with the cover plate having a suitable thickness (i.e., having a thickness to reduce, or ideally prevent, deflection of the cover plate under pressure).

Also required is a vacuum-tight seal formed between a surface of the cover plate and a surface of the baseplate. In this example embodiment, an O-ring 16 disposed between a surface of the baseplate and a surface of cover plate 14a forms the vacuum seal about channels 12. Thus, the O-ring is configured to maintain vacuum in the baseplate channels once the top plate is disposed over the baseplate.

Also required are inlet and outlet channels (see FIGS. 18A-18C) through which a molten metal (e.g., solder) may respectively be introduced into and exit from the baseplate channels 12. Such inlet and outlet channels may be provided in top cover plate 14a, bottom cover plate 14b and/or the baseplate 12.

Also, if there is more than one channel in proximity (as illustrated in FIG. 2), a gasket 15a may be disposed between the top cover plate 14a and a top surface of baseplate 10. Gasket 15a may be configured and disposed to prevent a molten metal (e.g., solder) from travelling (or leaking) between channels 12 and to help assure and/or improve the flow of molten metal through the baseplate channel from inlet to outlet. In embodiments, gasket 15a may be provided from a compressive material. In embodiments, plate 14a may be provided having one or more cutouts (or recessed regions) in a surface thereof in which gasket 15a may be disposed.

Depending upon the size of the object to be soldered (e.g., the size of the baseplate and open channel(s)), and the required pressure for adequate flow, further additions may be useful or required. Such further additions may include compression plate 14b (sometimes referred to herein as a “second cover plate,” “bottom cover plate” or more simply a “bottom plate”) disposed on a surface of the baseplate opposite the baseplate surface over which the top plate is disposed. In this example embodiment, bottom plate 14b is disposed over so-called cooling channels 13. A gasket 15b is disposed over the second surface 10b of plate 10 and is also disposed around channels 13. In embodiments, gasket 15b may be provided from a compressive material. In embodiments plate 14b may be provided having one or more cutouts (or recessed regions) in a surface thereof in which gasket 15b may be disposed.

The bottom plate 14b is configured (e.g., provided having a size, shape and thickness) selected to reduce deflection and/or deformation of the baseplate. Such baseplate deflection and/or deformation may be due to pressure and temperature to which the baseplate may be exposed during a metal filing process (e.g. a VPI process). Thus, using top and bottom baseplates 14a, 14b may help equalize (or substantially equalize) thermal expansion and reduce thermal deflection. In embodiments, pressures of up to 30 pounds per square gauge (psig) and temperatures in the range of 200° C. may be used during a process for filling the open channels 12 with a molten metal.

The combination of the baseplate, top plate, bottom plate (if present) along with any associate sealing and/or coupling mechanisms used to secure the top and/or bottom plates to the baseplate may be referred to herein as a “VPI plate assembly” 20 (or more simply a “plate assembly”). In embodiments, the top and/or bottom plates 14a, 14b may be provided from aluminum or other materials having thermal conductivity and thermal mass characteristics substantially the same as or similar to aluminum as such thermal conductivity characteristics are relatively high compared with thermal conductivity of other materials and such thermal mass characteristics which are relatively low compared with thermal mass characteristics of other materials. Materials other than aluminum may, of course, also be used.

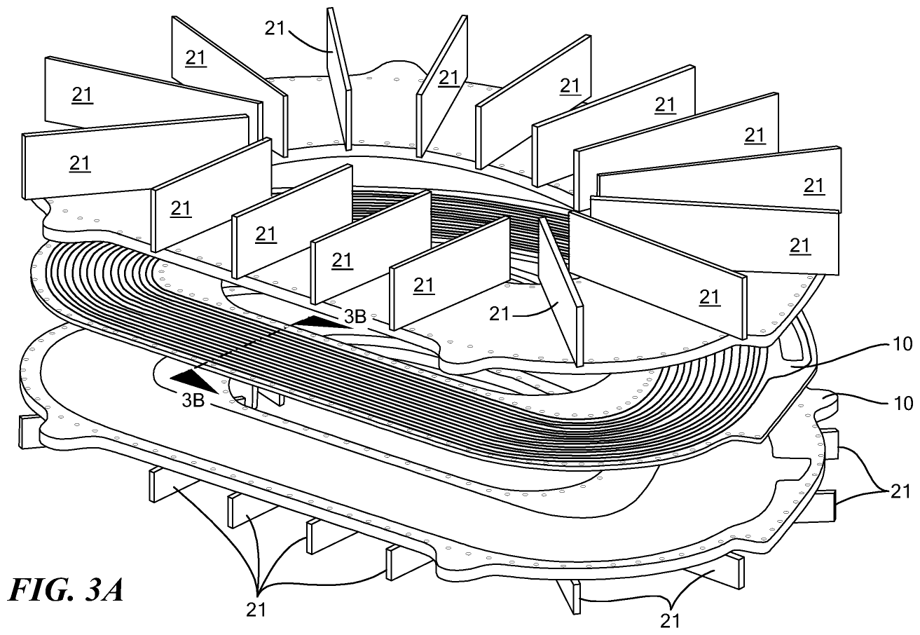

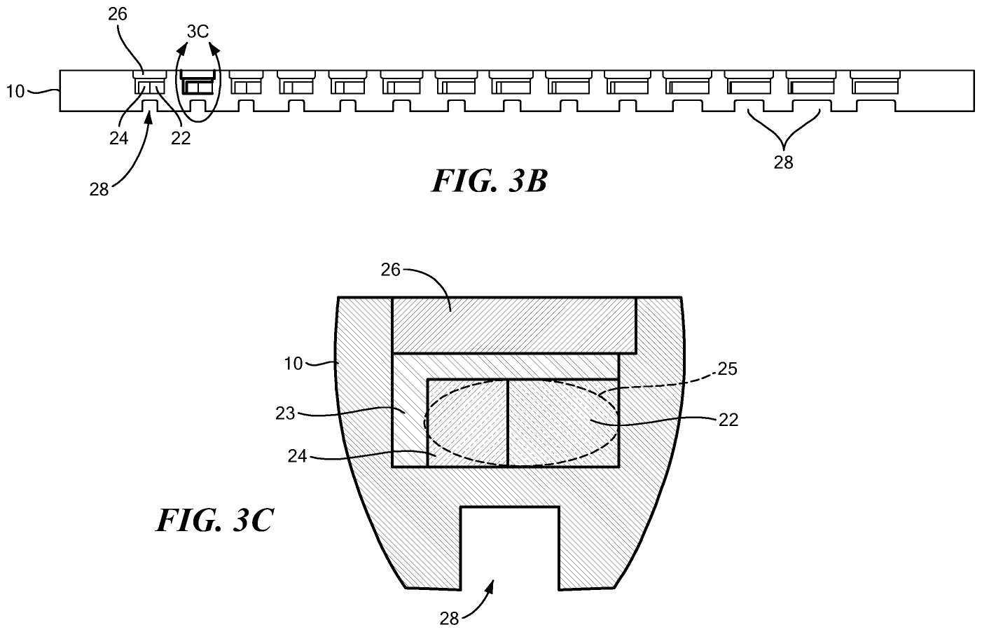

With reference now to FIG. 3A, such further additions noted above may also include mechanical structures 21 (sometimes referred to herein as “stiffeners”) configured and disposed to further reduce deflection of the top cover plate (and, if present, bottom cover plate) under pressure. In embodiments, the distance of such deflection is preferably less than the compression of the bottom gasket (i.e., the amount (or physical distance) by which the bottom gasket compresses) to avoid channel to channel metal solder leakage (since such leaked solder may result in one or more electrical current paths or “electrical bridges” between channels, impairing the operation of the magnet, and/or may also prevent solder from completely filling all channels). Although in FIG. 3A the stiffeners are illustrated as a series of fins projecting from or disposed on surfaces of the top and bottom plates, other mechanical structures or other means may also be used to reduce deflection of the first and second plates.

Also, in those embodiments in which a solder outlet is provided in the top cover plate, an opposite hole on the bottom of the baseplate and the bottom cover plate (if present) may be included to provide for more complete draining of flux prior to solder.

### Solder Flow Channel

To assure complete metal filling about an HTS material (e.g., an HTS tape or a stack or bundle of HTS tapes) disposed in an open channel, the configuration (e.g. the configuration of the baseplate channel and top plate) should preferably include sufficient open space for a molten metal (e.g. solder) to flow unimpeded and fill the HTS baseplate channels with a molten metal in an amount of time and at temperatures which do not degrade mechanical or electrical characteristics of the HTS material. The needed amount (or size) of such open space (or “gaps”) to enable such unimpeded molten metal flow (e.g., solder flow) will depend upon the particular application including but not limited to dimensions of the baseplate channels, selection of metal (i.e., a molten metal or a particular type of solder) and HTS material disposed in the channels as well as dimensions of any co-wind-material which may be disposed in the baseplate channels. In embodiments, hydraulic diameter of the space may be used to estimate flow time. Longer HTS channels will require a larger hydraulic diameter to fill in a given time. In embodiments, gaps of typically one (1) millimeter (mm) to a few mms are needed for some applications.

In an embodiment, a diameter of a few mms (e.g., in the range of about 3 mm to about 4 mm diameter) was used to solder on the order of 100 m channels (i.e., channels having a length on the order of 100 m were filled with metal). It is noted that the largest flow channel is one significant factor in flow (e.g., the sum of many thin channel ones will not be as large of a factor).

In embodiments, an HTS tape may be disposed in the baseplate channel (e.g., channel 6 on FIG. 1 or channel 12 in FIG. 2) prior to the channel being filled with metal. The HTS tape may comprise a long, strand of HTS material having cross-sectional dimensions in the range of about 0.001 mm to about 0.1 mm in thickness (or height) and a width in the range of about 1 mm to about 12 mm (and with a length that extends along the length of the channel, i.e., into and out of the page in the examples of FIGS. 2 and 3B). According to some embodiments, HTS tapes may comprise an HTS material in addition to cladding materials such as copper. In some embodiments, HTS tape may comprise a polycrystalline HTS and/or may have a high level of grain alignment.

### Rectangular Channel.

FIGS. 3B and 3C illustrate an example of a baseplate 10 in which the channels 12 (FIG. 2) have disposed therein stacked HTS tapes 22 (also referred to as an HTS tape stack 22) and co-wind tapes 24 (co-wind tapes may be provided from an electrically conductive material such as copper). The combination of stacked HTS tapes 22 and co-wind tapes 24 (if any) taken together is sometimes referred to herein as “co-wound HTS tapes 25”.

In some situations in which the HTS material is provided as an HTS tape, it may be desirable to vary the number of HTS conductors in an HTS tape stack 22 according to the location of the HTS tape stack within a device (e.g. a magnet such as a NINT magnet), thereby reducing the total amount of HTS tape needed to construct the device. FIG. 3B illustrates an example of a plate in which the baseplate channels have disposed therein a stack of HTS tapes 22 in addition to conductive co-wound tape 24 (e.g., copper tape). A conductive material 23 (e.g., a metal such as solder) is disposed about the co-wound HTS tapes 25.

As may be observed in FIG. 3B, the number of HTS tapes in each HTS tape stack 22 is decreased in each turn going from right to left in FIG. 3B, while the number of conductive co-wound tapes is increased right-to left which increases the thickness of conductive co-winds 24. The example embodiment of FIG. 3 also includes an optional channel cap 26 disposed over the open channel in the baseplate (e.g., such as open channel 12 in FIG. 2). The width of the channel cap may be varied in conjunction with number of conductive co-wound tapes such that their combined cross-sectional area is roughly constant in every turn. In this way, the resistance per unit length of the co-conductor is maintained constant which may be desirable in some applications.

In the case of an HTS NINT magnet, tuning the amount of HTS tape, co-wound conductive tape, and the size of the channel cap may provide a way to control the rate of magnetic energy dissipation during a quench, and in some cases may dissipate the magnetic energy uniformly throughout the winding pack during a full magnet quench event. In addition, tuning the amount of HTS tape, co-wound conductive tape, and the size of the channel cap may alter an amount of magnetic energy deposition in adjacent areas. This may allow, for instance, reduction of the magnetic energy deposition in critical areas such as in regions with joints.

In the example of FIG. 3B, the baseplate includes cooling channels 28 arranged on the opposite side of a plate from the open channels 12 (also sometimes referred to as conducting channels or HTS channels when HTS material such as HTS tapes or HTS tape stacks are disposed therein). Cooling channels 28 may be provided having varying widths (i.e., the width of each cooling channel need not be the same). In embodiments, there may exist a concomitant relationship between the width of a cooling channel 28 and the width of an HTS tape stack 22 proximate the cooling channel. For example, the wider the HTS tape stack, the wider the cooling channel. In some cases, it may be preferable to provide the cooling channels 28 within the conducting channels.

In embodiments cooling channels could be provided between the conducting channels. It is noted that the cooling channels should be blocked from solder to avoid flowing solder into the cooling channels. This could be accomplished, for example, by laying a tube in the channel beside (e.g., adjacent or proximate) the HTS.

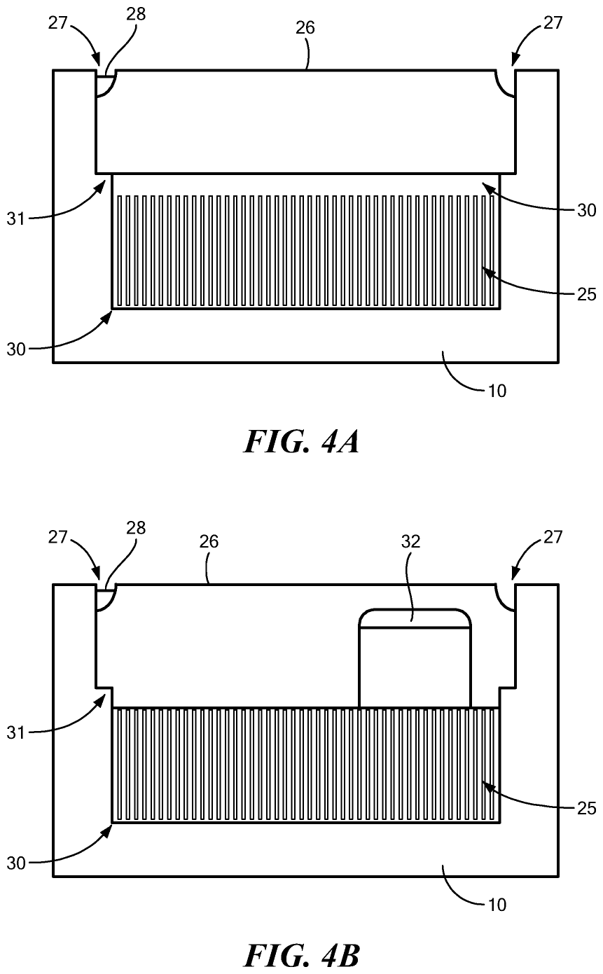

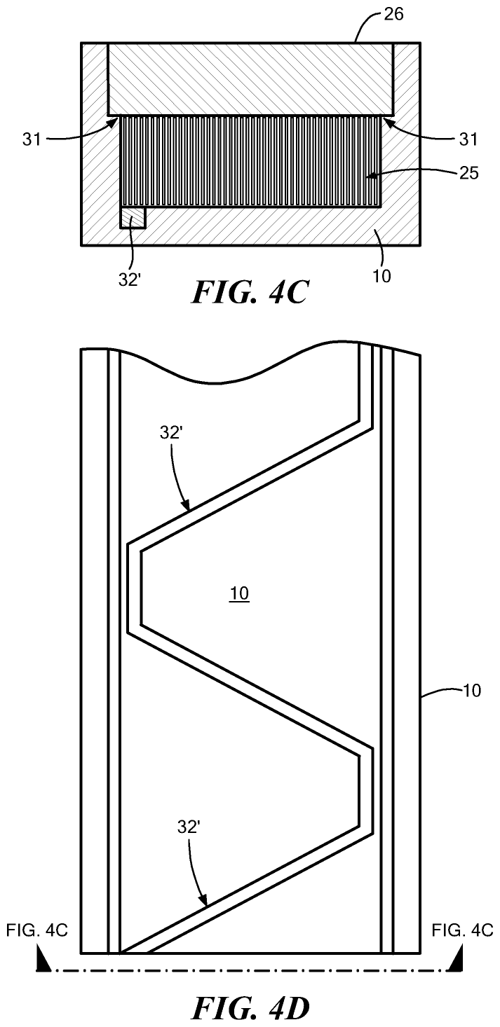

Referring now to FIGS. 4A, 4B, in embodiments, the channel cap 26 may be configured such that when the channel cap is disposed in an open channel, a channel or groove 27 is formed along an edge of the channel cap. A solder paste or wire 28 may be placed on or otherwise disposed along the edge in channels 27. The solder is melted in the channels 27 to help ensure a good bond between the channel caps and the baseplate walls (a good bond may be important in the event of a magnet quench, for electrical and thermal conductivity between the channel cap and the baseplate).

In this example embodiment, a space (or “gap”) 30 through which a molten metal may flow is left between the HTS stack (or co-wound HTS tapes) in the channel and a flat channel cap (more clearly illustrated in FIG. 4A). Space 30 may also be provided beside the co-wound HTS tapes 25 so as to allow good wicking around the HTS tapes 22. The gasket and top plate discussed above would be disposed directly on top of the channel caps and baseplate. In other designs, the channel cap may not be needed and the top plate might be disposed directly over the open channels (i.e., in physical contact with the baseplate but still leaving a space between the HTS stack (or co-wound HTS tapes) in the channel and a surface of the top plate. In this case, care may be needed to avoid blocking the space with the gasket.

The design illustrated in FIG. 4A has the advantage of simplicity; the channel caps are simple to manufacture and, as illustrated in FIG. 4A, may be disposed on (i.e., may be “sitting on”) one or more detents 31 (which may form a “shelf”) in the baseplate so as to assure the existence of a gap 30 above the stacked tape. Such a gap serves as a channel through which a molten metal (e.g., solder) may flow. In some applications, gap 30 is relatively narrow (e.g., 1-2 mm) compared with the height and/or width of the channel. The particular dimensions of the gap will depend upon the particular application. After reading the disclosure provided herein, one of ordinary skill in the art will appreciate how to select particular gap dimensions for use in particular application, in order to fill the channel in a time which will not degrade HTS.

In practice, it may be difficult to maintain gap uniformly along a baseplate channel having HTS material disposed therein. Non-uniform gaps can cause partial or complete blocking of solder flow within the gap or channel. Effects which can lead to non-uniform gaps include, but are not limited to: achievable tolerances in fabricating a baseplate (including all baseplate features such as detents); achievable tolerances in fabricating a channel cap; bending of the baseplate due to differential thermal expansion of baseplate and cover plate (for example, if the plate ends bend downward and tape remains straight, the channel will shrink in the middle); channel cap slipping off the ‘shelf’ (e.g. the detent in the channel region of the base plate) due to combination of gasket compression and thermal expansion of plates; and tapes ‘floating’ to the top of the baseplate channel, due to lower density than melted solder or other molten metal.

Any of these effects, or any combination thereof, could cause solder flow (or more generally molten flow) within a baseplate channel to slow or completely stall, leading to incomplete, very slow or non-reproducible solder-filling.

Once molten metal fills the gap 30 and solidifies, the gap 30 is filled with the metal.

### Cap in Channel

Referring now to FIG. 4B, rather than relying on a space beneath the copper cap for flow of molten metal (as illustrated in FIG. 4A), to overcome the above-noted challenges, the concept of a channel cap comprising one or more solder flow channels (also sometimes referred to simply as “solder channels”) was conceived. As may be clearly seen in the illustrative embodiment of FIG. 4B, the channel cap 26 comprises a channel 32 specifically for solder flow. Although only a single channel is shown in this example embodiment, those of ordinary skill in the art will appreciate that in some embodiments, a channel cap comprising two or more solder flow channels may be used. In embodiments in which a channel cap comprises a plurality of solder flow channels, such solder flow channels may or may not intersect. Such a solder channel 32 may have any one of a number of cross-sectional shapes including, but not limited to rectangular or substantially rectangular (as illustrated in FIG. 4B), semi-circular or another shape. When the cap has a solder channel provided therein, the space below the cap (i.e., the space or gap between a surface of the cap and edge portions or surfaces of HTS tape disposed in the channel) can be smaller than when the cap does not include a solder channel (e.g., as shown in FIG. 4A). In some embodiments, the space between the channel cap and HTS tape 22 (or co-wound HTS tapes 25) may not be needed.

Furthermore, by providing a solder channel in the channel cap, a hydraulic diameter (and thus flow rate), which is larger than that achievable in non-channel cap embodiments (such as shown in FIG. 4A) can be achieved. In embodiments, the channel cap may comprise copper. Thus, by providing a solder channel in a copper channel cap, a hydraulic diameter, which is larger than that achievable in non-channel cap embodiments can be achieved while preserving the same amount of copper for magnet performance.

Utilizing a channel cap having a solder channel provided therein may resolve at least the issues of: preserving an open channel for the flow of a molten metal in the event of bending of the baseplate; preserving an open channel for the flow of a molten metal in the event of bending or slippage of the cap; and preserving an open channel for the flow of a molten metal in the event of movement of HTS tape in the baseplate channel.

In some embodiments, the channel cap solder channel (or portions thereof) may be straight and located along a centerline of the channel while in other embodiments, the channel cap solder channel (or portions thereof) may be straight but offset from a centerline of the channel cap (e.g. as illustrated in FIG. 4B).

### Cap Having a Meandering Shape Solder Channel

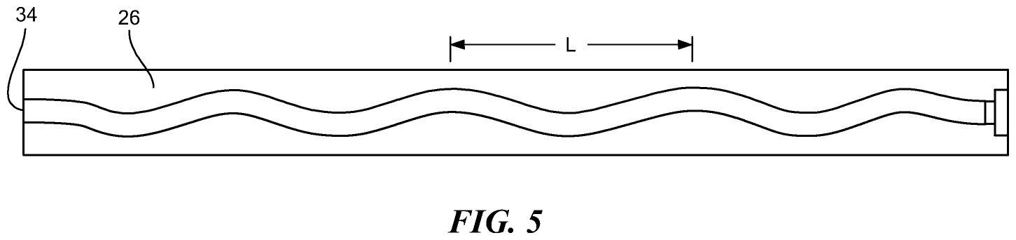

It is also recognized that if the solder channel in the channel cap is uniform along the HTS tape channel, the possibility still remains that HTS tapes could move (e.g., float up) and partially or completely block the solder channel in the cap. Thus, and referring now to FIG. 5, shown is a channel cap 26 having a solder channel 34 which meanders about a central longitudinal axis of the channel cap. A channel cap comprising a solder channel having a meandering shape (sometimes referred to herein as a “meandering solder channel” or more simply a “meandering channel” 34 or a “copperhead cap”). Use of a channel cap comprising a meandering solder channel may resolve the above noted issues of preserving an open channel for the flow of a molten metal in the event of bending or slippage of the channel cap and movement (e.g., floating) of the HTS material within a baseplate channel.

In meandering channel embodiments, the solder channel in the channel cap may not be straight, but may rather meander from side to side (e.g., about a centerline) as shown in the example embodiment of FIG. 5. In this example embodiment, the solder channel has a wave shape. In embodiments, the period L of the ‘waves’ is selected so that each section of a vertical HTS tape stack (which may be quite stiff in the vertical direction), is restrained at enough points (e.g., a plurality of points) sufficient to prevent significant movement (e.g., rising of the HTS tape into the channel of the channel cap). In some embodiments, the meandering-shape solder channel (or portions thereof) may meander about a centerline of the channel cap while in other embodiments, the meandering-shape solder channel (or portions thereof) may meander about an axis which is offset from a centerline of the channel cap. In some embodiments, a meandering channel within a channel cap may include straight sections of channel and sections which meander along the width of the channel cap. In some implementations, for instance, the meandering channel may be formed from a plurality of straight sections arranged in a skew apeirogon pattern (e.g., a ‘zig zag’ pattern), and/or may include straight channel sections connected by one or more curved channel sections.

A channel cap having a meandering solder channel as shown in FIG. 5 may find use in linear single-channels (i.e., baseplates having a single linear channel) as well as in spiral grooves (e.g. in spiral channels or grooves in a baseplate (as shown in FIGS. 1 and 3A) as may be used in a so-called pancake coil for a NINT magnet). A channel cap having a meandering solder channel results in molten metal flow rates suitable for use in HTS channels (i.e., channels in a baseplate in which an HTS tape may be disposed) and which substantially match predictions based on hydraulic diameter of the channel.

Referring now to FIGS. 4C, 4D, in which like elements of FIGS. 4A, 4B are provided having like reference designations, alternatively or in addition to a meandering solder channel in the channel cap as illustrated in FIG. 5, one or more meandering solder channels 32′ may be cut, formed or otherwise provided in an HTS channel of a baseplate 10 in which an HTS tape stack 25 is disposed. By providing a solder flow channel 32′ in an HTS channel (such as HTS channel 6 in FIG. 1, for example) a solder flow channel 32′ is disposed below and/or under the HTS tape stack 25.

In some embodiments, one or more solder flow channels within an HTS channel of a baseplate may include straight sections of channel and sections which meander along the width of the HTS channel within the baseplate. In the illustrative embodiment of FIGS. 4C, 4D, for example, the solder flow channel is formed from a plurality of straight sections arranged in a skew apeirogon pattern (e.g., a ‘zig zag’ pattern). In the example embodiment of FIGS. 4C, 4D, the solder flow channel may include interconnected straight channel sections.

Thus, the solder flow channel 32′ may comprise interconnected straight channel sections or may comprise one or more straight channel sections connected by one or more curved channel sections.

It should be appreciated, however, that solder flow channel 32′ may be provided having any suitable configuration (including but not limited to a sinusoidal or substantially sinusoidal configuration, a sawtooth or substantially sawtooth configuration, a serpentine configuration or the like),

It should be appreciated that while in the example embodiment illustrated in FIGS. 4C, 4D solder channel 32′ is illustrated having a rectangular cross-sectional shape, solder channel 32′ may be provided having any regular geometric cross-sectional shape (e.g., square, semi-circular, oval, triangular) or an irregular geometric cross-sectional shape.

Thus, the techniques described herein are not limited to use with solder flow channels having the particular shapes illustrated or having any particular shape. For instance, any of the solder channels described herein could have a half-circle cross-sectional shape (or another other suitable cross-sectional shape) rather than the rectangular or square cross-sectional shapes shown in the figures.

Although only a single channel is shown in this example embodiment, those of ordinary skill in the art will appreciate that in some embodiments, an HTS channel in a baseplate may comprise two or more solder flow channels. In embodiments in which an HTS channel comprises a plurality of solder flow channels, such solder flow channels may or may not intersect.

According to some embodiments, the channel caps of FIG. 4A, 4B or 5 may comprise, or may consist of, copper. Other electrically and thermally conductive material may, of course, be used to provide a channel cap. In embodiments, the shapes of the HTS and the cap in the plate of FIGS. 4A, 4B may be that of a spiral (e.g., a racetrack spiral as shown in FIGS. 1 and 3A).

As shown in FIGS. 4A, 4B, the cap 26 is arranged within an upper section of a baseplate channel that is wider than the lower section in which are located the HTS and/or co-wind material as illustrated in FIGS. 3B-4B. In some embodiments, after assembly, conductive molten metal (e.g., solder) may be introduced into the baseplate subsequent to arranging the HTS and channel cap within an open channel of a baseplate. As a result, the solder may fill the space between the HTS and cap and/or may fill any space around the sides of the HTS and/or channel cap, should such space be present prior to filling or otherwise occupying the space with the solder.

In some embodiments, the HTS tape stack (or one or more HTS tapes which comprise the HTS tape stack) may be pre-tinned with a metal (e.g., a PbSn solder) to promote a good bond between the HTS and the molten metal. According to some embodiments, the solder or other molten metal material may be deposited via a vacuum pressure impregnation (VPI) process. Such a VPI process will be described herein in detail herein below. Briefly, however, the process may comprise one or more of the following: cleaning the open baseplate channel using an acidic solution following by a water rinse; evacuating the space within the open channel (i.e., forming a vacuum in or around the open channel); purging the open channel with an inert gas; depositing flux into the open channel to coat the HTS and the conductive material; draining any excess flux from the baseplate channel; again evacuating the channel; heating the baseplate (and any optional cover plates) to a temperature at, or above a temperature at which the metal to be deposited in the open channel will melt (i.e., to form a molten metal); and flowing a molten metal (e.g., a molten alloy such as PbSn solder) into the plate.

In the example embodiments of FIGS. 4A, 4B, it will be appreciated that while particular shapes (i.e., cross-section shapes and/or configurations) of the baseplate channels as well as particular shapes of the channel cap solder channels are illustrated, the techniques described herein are not limited to channels with these particular shapes. For instance, the channels could have a half-circle cross-section instead of the rectangular cross-section shown, or another other suitable cross-sectional shape.

### Segmented Channels

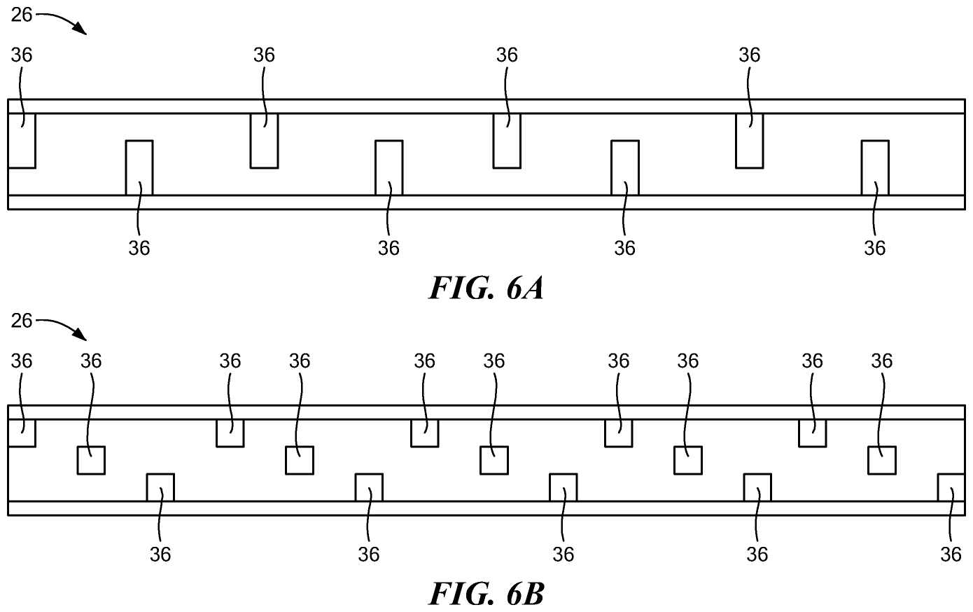

FIGS. 6A, 6B illustrate segmentation structures 36 provided therein. Segmentation structures 36 are arranged within a space through which a molten metal may flow. The space may correspond for example to a solder flow channel such as solder flow channel in a channel cap (e.g., as in FIG. 4B) or a solder flow channel in an HTS channel of a baseplate (e.g., as in FIGS. 4C, 4D).

The segmentation structures address the issue of blocking a channel in which molten metal may flow, due to HTS tape moving (e.g., rising or floating or otherwise moving) in the baseplate channel. In embodiments utilizing segmentation structures 36 (which result in a segmented channel in which a molten metal may flow), the gap could be uniform across the full width of a baseplate channel in which an HTS tape is disposed, but spacers (e.g., solid spacers) are disposed in the channel (e.g., as segmentation structures) which keep the channel cap raised, while still allowing solder to flow. Thus, FIGS. 6A, 6B illustrate a channel having one or more segmentation structures disposed therein, wherein the segmentation structures are configured to direct the flow of solder through a baseplate channel. The segmentation structures are configured in the channel to help prevent compression of the channel and prevent tapes from rising, and thereby allow substantially unimpeded flow of a molten metal within the channel. In embodiments, the segmentation structures 36 themselves may have openings (or channels) provided therein. The segmentation structures 36 may comprise any solid material that can be arranged to impede solder flow within a channel and may comprise copper or another metal. In some embodiments, the segmentation structures 36 may be integrally formed on the underside of the channel cap 26.

### Heating of a VPI Plate Assembly.

To flow a molten metal (e.g., solder) through the channels, the baseplate and HTS stack must be at sufficiently high temperature to maintain the metal to be flowed in a liquid state (or a substantially liquid state). The required temperature depends upon the type of metal (e.g., the type of solder) used. For example, a common tin-lead solder (Sn₆₀Pb₄₀ solder) has a liquidus of about 191° C. The process described herein for use with HTS tapes disposed in open channels of a baseplate typically has a target temperature of 200° C. It is also possible to use a slightly lower temperature (e.g., in the range of about 196° C.-to about 198° C.) albeit with smaller margin to assure flow. At such temperatures, mechanical and/or electrical degradation of HTS tape due to thermal exposure and solder exposure is a concern. Thus, it is important to reduce, and ideally minimize, the amount of time for which HTS tape is exposed to such temperatures while also maintaining uniformity of the solder (or other metal) disposed it the channel.

Two techniques (i.e., methods and associated systems) have been developed to achieve the required temperatures while limiting the amount of time for which an HTS tape is exposed to such temperatures (i.e., to limit a maximum temperature to which HTS tape is exposed during a metal filling process and to reduce the amount of time for which HTS tape is exposed to such temperatures during a metal filling process).

A first technique (to be described below) comprises the use of a heat chamber (e.g., an oven) in which a VPI plate assembly (e.g., such as VPI plate assembly 20 in FIG. 3A) is disposed. Briefly, the technique comprises placing a VPI plate assembly (or even a NINT magnet) in an oven (i.e., in an oven sized to hold the NINT magnet or VPI plate assembly) and heating the magnet or VPI plate assembly using convective heating. This approach has the advantages of: simplicity, temperature uniformity and reduction (and ideally avoidance) of risk of heating the NINT magnetic or VPI plate assembly above a desired temperature. However, a baseplate for a NINT magnet may have a relatively high thermal mass and time scales for heating high thermal mass assemblies by convection alone can be can long (several hours), which may make for an inefficient process and potentially risks thermal degradation of HTS).

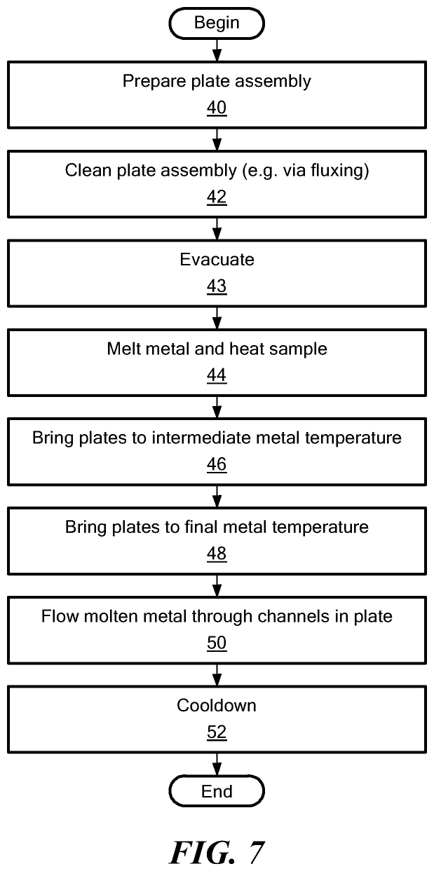

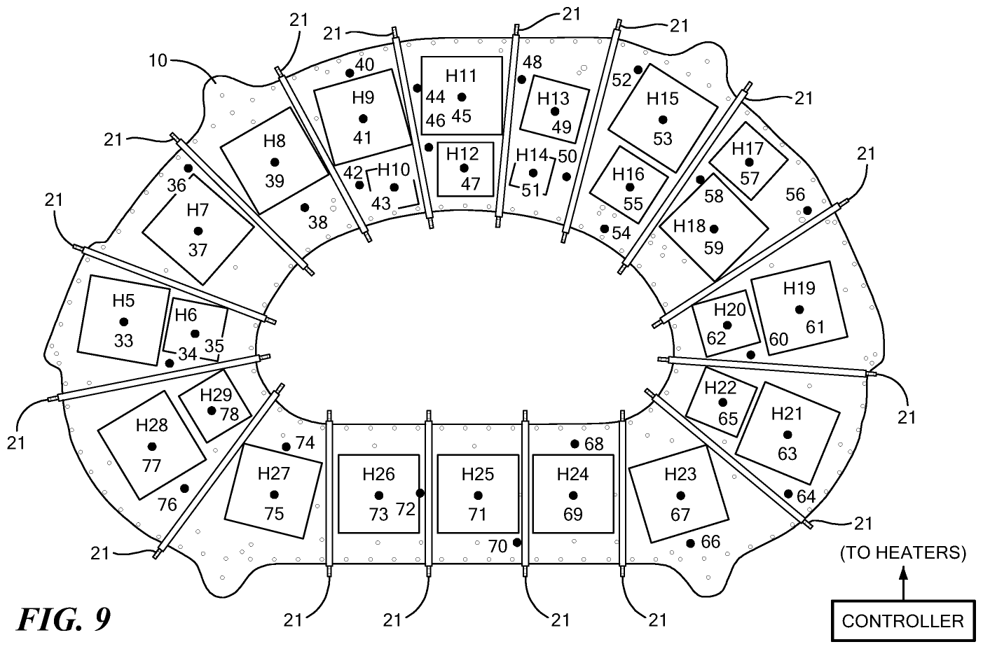

A second technique (to be described in conjunction with FIG. 7) comprises the use of heaters (e.g., resistive heaters) coupled to a VPI plate assembly. Briefly, in embodiments, one or more resistive heaters may be thermally coupled to a cover plate disposed on a baseplate. In embodiments which include both top and bottom cover plates, one or more heaters may be coupled to both cover plates. In embodiments, heaters may be applied to or otherwise thermally coupled to one or both cover plates (e.g., top and bottom plates 12, 14 in FIG. 2). The heater approach can reduce (and in some cases greatly reduce) the time required to heat a baseplate assembly. Uniformity of temperature in the baseplate assembly, however, may become a concern. If there is a large difference between top and bottom plate temperatures, the baseplate may deflect. During the process, limits may be set on the allowable temperature difference to avoid this risk. Differences in temperature between regions of the baseplate could result in some sections of HTS receiving higher thermal exposure. This should be avoided by choice of heater power and placement for a given application. An example embodiment is shown in FIG. 9. Use of thermally conductive adhesive between heaters and a surface of a compression plate or a surface of a baseplate can reduce (and ideally minimize) temperature differentials between heaters and plate, increasing heater lifetime and making coupling of heater power more efficient. This heater technique may be used in place of or combined with the use of a heat chamber as described above. If a heat chamber is not used, it will be necessary to separately maintain temperatures of all components along the solder flow path high enough to keep the solder liquid.

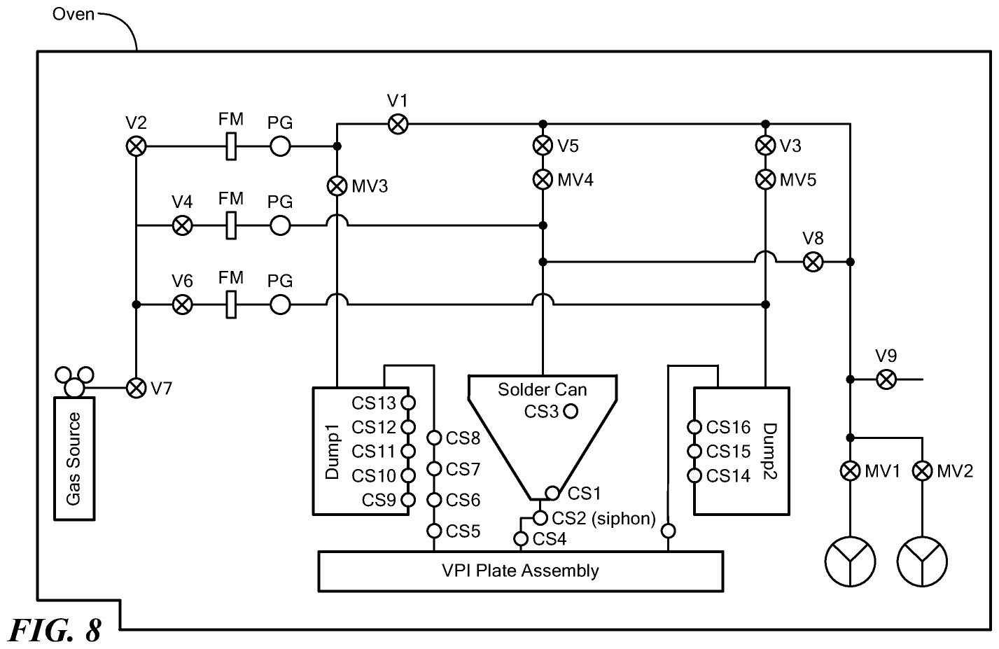

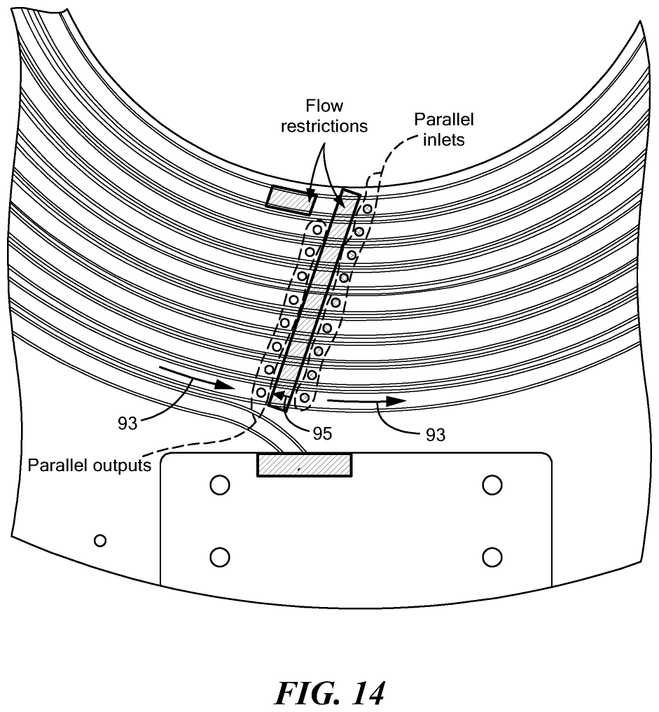

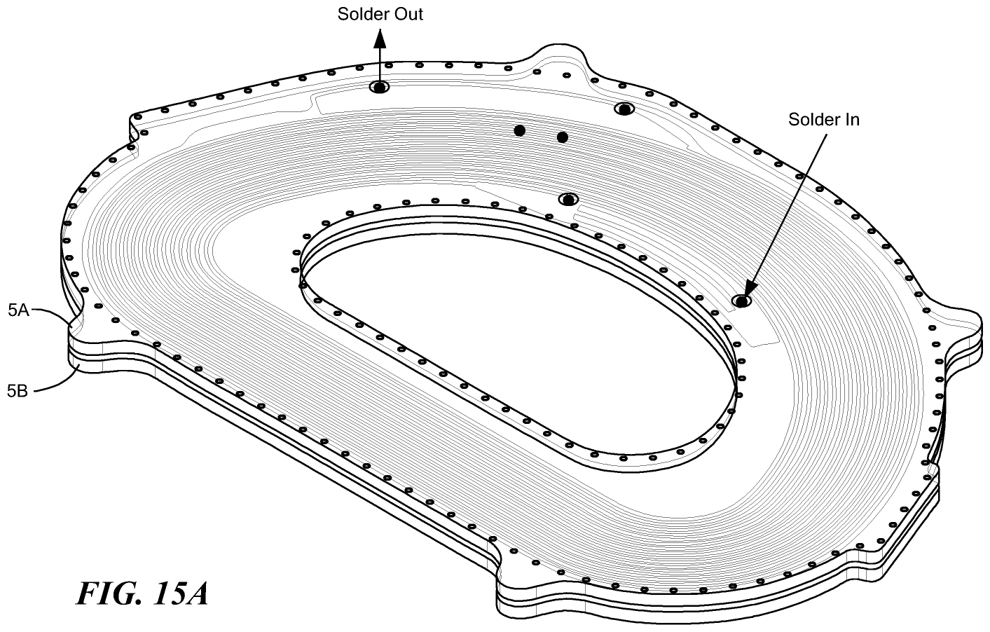

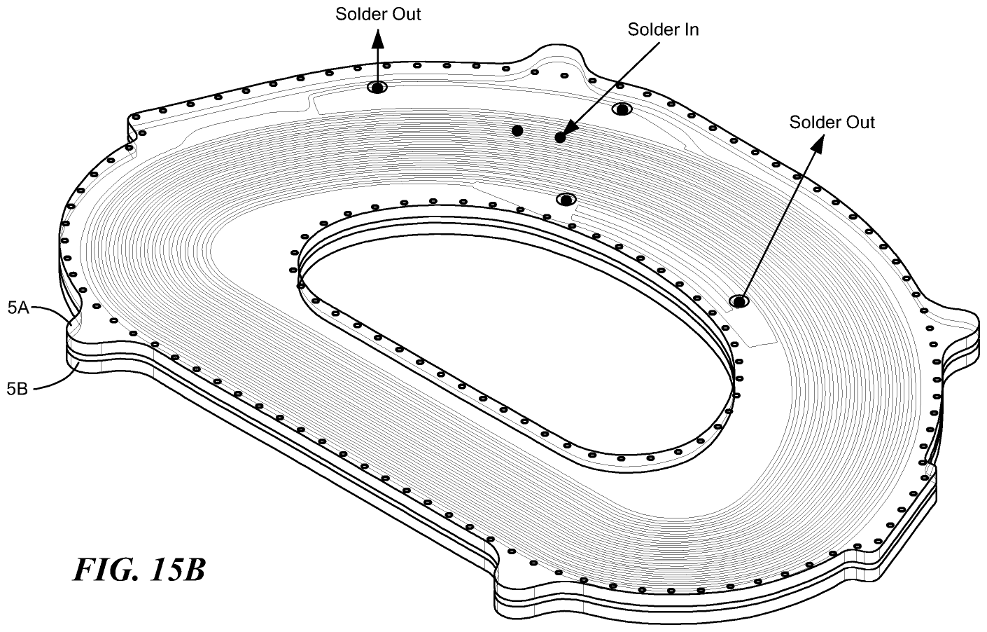

In general overview, during a solder flow process, solder is pressurized with a gas while a baseplate channel outlet is kept under vacuum, thereby providing a pressure gradient along the HTS channel. In embodiments, the gas may be provided as Argon but other gases may, of course, also be used. One embodiment of a VPI plate assembly, illustrated in FIG. 8 (and also in FIG. 15A), uses a baseplate having a single channel inlet and single channel outlet. In other embodiments, a VPI plate assembly may include one or more inlets and/or one or more outlets (e.g., as illustrated in FIGS. 14 and 15B).

The time to flow solder scales more than linearly with channel length. Thus, for embodiments having a baseplate with channels long and thin enough that flow time could degrade HTS, it may be desirable to have a VPI plate assembly with a molten metal inlet (e.g., a solder inlet) part way through the channel rather than at an end of the channel, and two outlets at each end. Such an embodiment is described below in conjunction with 15B. It has the advantage of no parallel paths, still ensuring complete fill and flushing of flux. Still other embodiments may utilize a VPI plate assembly with multiple inputs and multiple outputs (FIG. 14).

Referring to FIG. 7, in one embodiment a VPI process for metal filling open channels in a plate begins by preparing a VPI plate assembly as shown in processing block 40. Such preparation may include winding an HTS tape (and optionally a co-wind) in an open channel of a baseplate and disposing channel caps (optionally having a solder channel provided therein) in the open channel above the tape stack. A compressive gasket (e.g., provided from silicon or other material having similar mechanical and electrical characteristics) is disposed between a surface of a top compression plate and a surface of a baseplate having the channel cap disposed thereon. In embodiments, other materials or a combination of materials such as Teflon, Viton or Aramid fiber sheets may be used. A compression plate is then disposed over the baseplate. If the VPI plate assembly also includes a bottom compression plate, a compressive gasket may also be disposed between a surface of the bottom compression plate and a surface of the baseplate. This is not needed for vacuum seal but may help to equalize friction between top and bottom plates and thus reduce deflection during heating and cooling.

As noted above, O-ring seals (e.g., as shown in FIG. 2) may be used around the sections of the top plate and baseplate to aid in ensuring the channel may be placed under vacuum.

In embodiments, a solder paste or wire (e.g. solder paste or wire 28 illustrated in FIGS. 4A, 4B) may be placed on or otherwise disposed along the edges or channels (e.g. gaps or channels 27 illustrated in FIGS. 4A, 4B which will not be in the VPI solder channel), to ensure a good bond between the channel caps and the baseplate.

To further improve the bond between the channel cap and the baseplate, solder paste may be disposed between side-surfaces of the channel cap and side surfaces of the baseplate channel in regions in which the channel cap is disposed (e.g. by disposing solder paste on side-surfaces of the channel caps before the channel caps are placed into the channels).

Openings are left for fittings at molten metal inlet(s) and outlet(s), typically on the top plate and the baseplate, and also on the bottom plate to drain flux (e.g. in the case where liquid flux is used).

The entire VPI plate assembly (e.g. baseplate, compression plate(s) and stiffeners) is coupled together (e.g. using bolts, fasteners, clamps or any other type of coupling or fastening means). As noted above, the stiffeners are optional and may be included where needed to reduce plate deflection. Coupling the VPI plate assembly compresses the O-rings, which form a primary vacuum seal, and the gasket onto the ridges between channels.

Once the VPI plate assembly is coupled together, the plate assembly can be evacuated or “pumped down” (i.e. a vacuum may be drawn on the VPI plate assembly) and prepared to be heated (e.g. placed in a heating chamber such as an oven). Heaters and thermocouples may then be coupled to the VPI plate assembly and associated VPI filling structures. The heaters and thermocouples may optionally be tested. Such testing may involve cycling (i.e. raising and lowering) the temperature of the resistive heating elements and/or the heating chamber. Other testing techniques may also be used.

The VPI plate assembly should be cleaned as shown in processing block 42. In embodiments in which the metal to be melted and flowed through the channel(s) is solder (e.g., tin-lead solder), cleaning may be accomplished via the use of flux. In embodiments, fluxing may be used to remove oxidation and helping attain a good solder bond. In embodiments, liquid flux may be poured or otherwise provided in the solder inlet, and pressurized with gas to fill the channels. In embodiments, RMA5 flux and Argon gas may be used. In embodiments, other fluxes suitable for the materials of the HTS, baseplate and caps, if present, or other gases may be used.

In embodiments, once the channels are filled with liquid flux, pressure may be increased to force liquid flux around and into the HTS stack. In embodiments, a pressure of 15 psig held for 5 minutes may be sufficient.

The outlet (or outlets in case of dual flow such as shown in FIG. 18B) are coupled to (or otherwise in fluid communication with) tubing and the inlet may be pressurized to remove as much flux as possible.

If the VPI plate assembly includes bottom drain holes, the drain holes may then be opened and gas flow continued to remove flux (if any remains present).

The VPI plate assembly is coupled to solder inlet and outlets and sealed. A process of pumping and gas purging may be used to reduce any alcohol component remaining in the channels prior to the solder process.

Next described in processing blocks 43-50 is an example solder process. As shown in processing block 43 the assembly and solder can are evacuated before heating. This is important since liquid fluxes may turn solid if they oxidize. Also having pressure differentials could prematurely start solder flow.

As shown in processing block 44, metal (e.g., solder) is melted and the VPI plate assembly may be heated. These processes may or may not be carried out concurrently (i.e., the metal may be melted while heating VPI plate assembly). In embodiments, as shown in processing block 46, the VPI plate assembly may be heated, for example, in an oven or other heating chamber to a first solder temperature range of or about 180° C.

During this phase the oven (or heating chamber) setpoint may be raised to a temperature of or about 185° C. In embodiments in which heaters are disposed on or otherwise thermally coupled to the VPI plate assembly (e.g., as shown in FIG. 9), the heaters on the VPI plate assembly may be used in parallel with oven heating to speed the heating process until the VPI plate assembly reaches the first solder temperature of or about 180° C. and the heaters may also aid in uniformly maintaining this temperature on the VPI plate assembly.

Possibly in parallel, heaters on a solder can (e.g., electrical heaters on the solder can), and a heater on tubing which extends between the can outlet and a inlet of the VPI plate assembly, may be used to melt the solder and heat the tubing from the can to the VPI plate assembly. Thermocouples and contact sensors disposed inside the can, and near the outlet, may be used to determine when solder is fully melted and has reached target temperature, typically about 200° C. In an embodiment, HMI screens on PLC may be used to monitor the progress.

Vacuum is maintained throughout this solder melt/VPI plate assembly heating phase 44 without solder flow. This may be accomplished, for example, ensuring pressure on the solder can and any solder dump(s) is equalized thereby preventing solder flow. It is important to maintain an O2 free environment while heating the flux. Any residual vapors contained in the gas system may be exhausted via a pump exhaust.

The VPI plate assembly is then brought to an intermediate solder temperature as shown in processing block 46. Once solder is melted and at target temperature, and plates have equilibrated at oven temperature, the plate temperature is increased via oven and heater setpoints. Thus, one step in the process which has been adopted to reduce (and ideally minimize) time spent near 200° C. is to bring the VPI plate assembly to an intermediate solder temperature of 193° C. and allow the VPI plate assembly to equilibrate. It has been experimentally discovered that HTS can be held at this temperature for at least two hours with little or even negligible degradation of HTS mechanical and electrical characteristics.

Processing then proceeds to processing block 48 in which the VPI plate assembly is brought to a final solder temperature. That is, the plates (e.g., compression plates and baseplate) in the VPI plate assembly are brought to a temperature at which solder can flow. It is noted that in some embodiments and choices of solder, there may be a relatively narrow temperature window (e.g., a temperature window in the range of about 195° C. to about 200° C.) for solder flow with little (and ideally, minimal) damage to HTS and it is important to reduce (and ideally, minimize) time-temperature exposure of the HTS.

In another portion of the process, a wait/soak period may be used to ensure HTS material (e.g., an HTS tape stack) has been heated to the same temperature as the plates. Any location (e.g., any location in the VPI system or in the channel baseplate) which is at a temperature below solder liquidus could inhibit or even stop the flow of solder. Such a wait/soak period may last from several minutes to hours depending upon the embodiment (e.g., plate and channel size and geometry and type of solder or other metal to be flowed through the channels. In some embodiments, a target temperature range of 198° C.-201° C. and a soak time of 10 minutes for a VPI plate assembly may be used.

In embodiments, once both the plates (e.g., compression plates and baseplate with HTS channels) and the solder are heated to a temperature within the target temperature range for a prescribed soak time, as shown in processing block 50, a VPI flow process may be performed to flow solder (or other molten metal) through the HTS channels. Contact sensors which close a circuit when solder is present may be used to monitor the progress of flow.

Once solder flow is complete (and ideally, as soon as flow is complete), a cooldown process 52 may begin. It is appreciated that some molten metals (e.g. solders used in the metal filling process) when in a liquid state are known to erode a copper (Cu) coating typically used on HTS tape and are also known to degrade HTS. In some embodiments it may thus be important, immediately after flowing solder (or other molten metal) through the channels and stopping flow, to cool the plate and solder as quickly as possible to solidus temperature. Multiple methods have been developed for to cool molten metal in channels of a baseplate suitable for use in a NINT magnet as will be described below. Temperatures of the plates may be monitored during the cooling process.

In one embodiment, cooldown may begin by turning off heaters (if any) and reducing the oven setpoint to room temperature and venting the oven. Oven venting may be accomplished by fully opening oven vents operating convection fans to cool the VPI plate assembly after filling baseplate channels with a molten metal. If water cooling is used, pumps to nozzles on cooling structures (e.g. spritzers) are turned on to spray water (or other cooling liquid) on at least some surfaces (and preferably most or all surfaces) of the VPI plate assembly. Once the temperature of the plate reaches solidus, pumps to the nozzles may be turned off. Convective cooling may continue until reaching a safe handling temperature.

After cooling, the inlet and outlet tubing may be cut or otherwise separated from the VPI plate assembly, the VPI plate assembly may be removed and then disassembled, leaving the completed metal filled baseplate (which may be a NINT coil or other shaped HTS object). The compression plates can be readily reused for VPI filling of another baseplate.

The method of solder filling described above results in excellent solder quality in the filled channels and results in high performance devices (e.g. high magnet performance). Also, the above method may be used with a VPI assembly having a single solder inlet and single solder outlet. Alternate methods described herein have also been conceived. Such alternate methods may be well suited to different applications.

For example, for baseplates having very long channels, one could reduce the path length through which it is necessary to flow solder by using multiple inlets and/or multiple outlets in a VPI assembly. The use of multiple inlets and/or multiple outlets in a VPI assembly may greatly reduce the flow time and thus solder exposure during a metal fill process. A system utilizing multiple inlets and/or multiple outlets may require additional valves in a vacuum/gas system compared with the number of valves required in a VPI plate assembly having a single inlet and a single outlet.

One example of a system utilizing a single central inlet and multiple outlets is described in conjunction with FIG. 8. The system of FIG. 8 utilizes a vacuum gas system allowing dual outlets and independent control of flow. FIG. 8 shows a VPI system suitable for use in filling channels in a baseplate of a VPI plate assembly with molten metal. Although in the below description of FIG. 8, reference is made to filling baseplate channels with solder, after reading the description provided herein, one of ordinary skill in the art will recognize that any metal or alloy capable of being melted and flowing in baseplate channels may be used.

Referring now to FIG. 8, illustrated is an example embodiment in which a baseplate has a channel with a single inlet located proximate a center of the channel, a first outlet proximate a first end of the baseplate channel and a second outlet proximate a second, opposite end of the baseplate channel. Thus, the baseplate channel has a central input and outlets at each end thereof.

In certain applications, this single inlet, dual outlet arrangement may be advantageous since, for the same pressure used to flow a molten metal, this arrangement may reduce solder flow time by about a factor of three compared with a single inlet, single outlet system. Reducing solder flow time reduces the amount of time HTS material disposed in the baseplate channel is exposed to liquid metal such as liquid solder (i.e. reduces the amount of time HTS material is exposed to liquidus). A reduction in the amount of time HTS material is exposed to liquidous can be significant in reducing degradation of mechanical and electrical (e.g., superconducting properties) characteristics of the HTS material (e.g., HTS tape).

It should be noted that the system of FIG. 8 includes valves MV1-MV5 and V1-V9) arranged so that, in the event flow rates are not identical, pressure at each outlet (i.e., VPI plate assembly outlets leading to respective one of dump tanks denoted Dump1 and Dump2 in FIG. 8) can be independently equalized once a target fill level is reached in each dump tank. Thus, there is little (or substantially no) risk of incomplete filling or flux trapping or running out of solder during a metal fill process.

It should be noted that the system of FIG. 8 also permits single-inlet/single outlet operation, which is adequate for many applications. In this embodiment the inlet is at one end of the channel and the outlet at the other, as in FIG. 15A, and only one dump is used.

Other necessary equipment for a NINT VPI solder process, includes but is not limited to a solder tank or crucible with heaters to melt the solder, and a set of contact sensors to monitor the progress of solder flow through the baseplate channel to the “dump” which holds excess solder.

With reference to FIG. 8, a VPI flow process may be performed as follows. Valve V5 to from pump to solder can is closed. Vacuum remains pumping on dump/outlet end. Argon pressure set to operating pressure, typically 5-30 psig. Valves V7 and V4 to Argon are opened, pressuring solder can. Flow valve is used to limit rate of rise. Solder is moved (e.g., drawn, pushed or otherwise forced) over inlet siphon into the baseplate inlet, through the baseplate channel, to the outlet(s), and into respective dump(s).

Progress of solder may be monitored via one or more of contact sensors CS1-CS16 disposed throughout the VPI system. When solder reaches a contact sensor at each location, a circuit may be closed (or activated) and an indicator is engaged (e.g. a visual indicator—such as a light—may be turned on or a sound indicator provided).

Once solder has reached a target level in the dump, determined by a contact sensor, flow is stopped. For Dump 1: Close V1 (stop pumping) and Open V2 (equalize gas pressure—e.g. argon (Ar) pressure—with can). In embodiments in which Dump 2 is also used, when that target is reached, valve V3 may be closed and valve V6 may be opened. Pressures on the two lines can thus be controlled independently.

Once the open channels are filled, a cooldown process may take place. Multiple techniques have been developed for to cool molten metal in channels of a baseplate suitable for use in a NINT magnet as will be described below.

FIG. 9 illustrates the use of heaters (e.g., resistive heaters) H5-H29 coupled to a VPI plate assembly to heat (or assist in heating) a VPI assembly to a target temperature. As can be seen in the example embodiment of FIG. 9, one or more silicon heaters may be disposed on a surface of a bottom compression plate. In embodiments, one or more silicon heaters may be disposed on a surface of a bottom compression plate, with the whole VPI plate assembly in a convection, uniformly heated oven. Thermally conductive RTV may be used to attach or otherwise mechanically and thermally couple the heaters to the surface of the bottom plate. A plurality of thermocouples may be embedded or otherwise disposed in each heater to measure temperatures and provide signals indicative of temperatures to a controller (e.g. a PID controller) which controls the operation of the heaters (e.g. controls whether heaters are turned on, off and/or the temperatures at which the heaters are set). Additional thermocouples may also be used to monitor the heating and temperature at a baseplate. In embodiments, such additional thermocouples may be attached, coupled or otherwise disposed on one or both of the top and bottom compression plates and/or attached, coupled or otherwise disposed on one or more of the baseplates and joints.

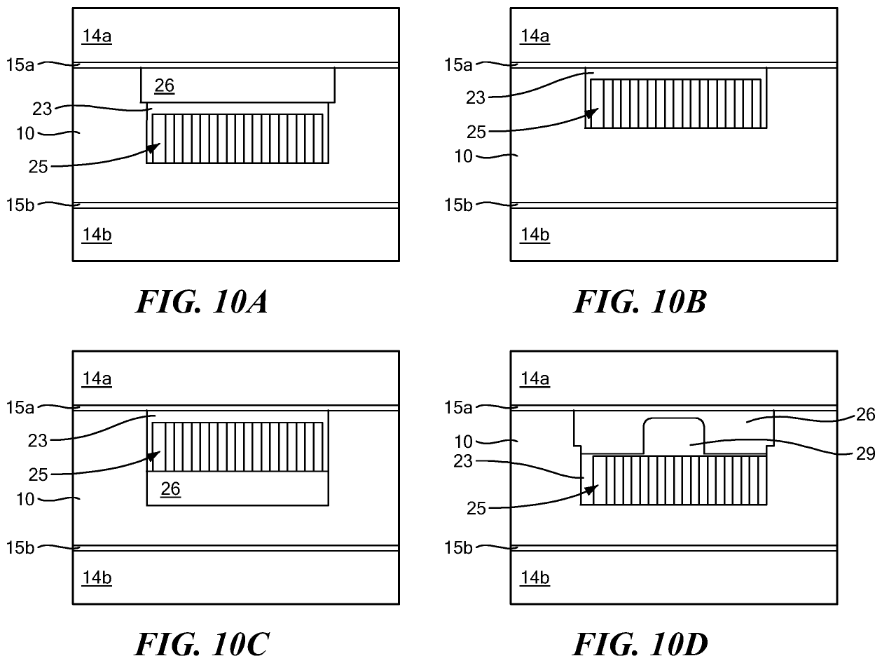

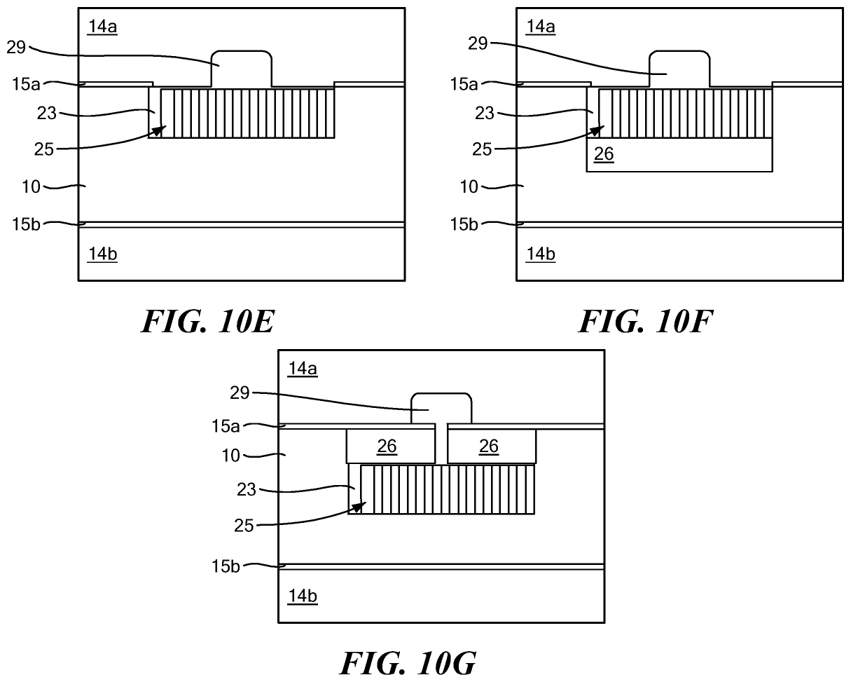

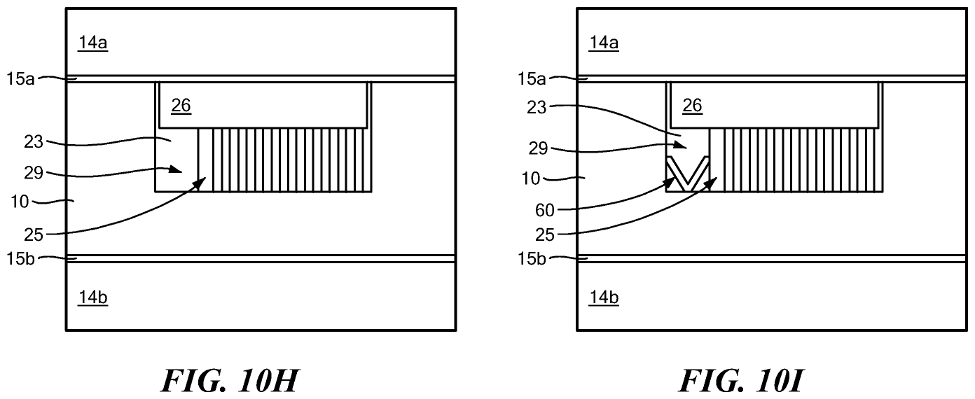

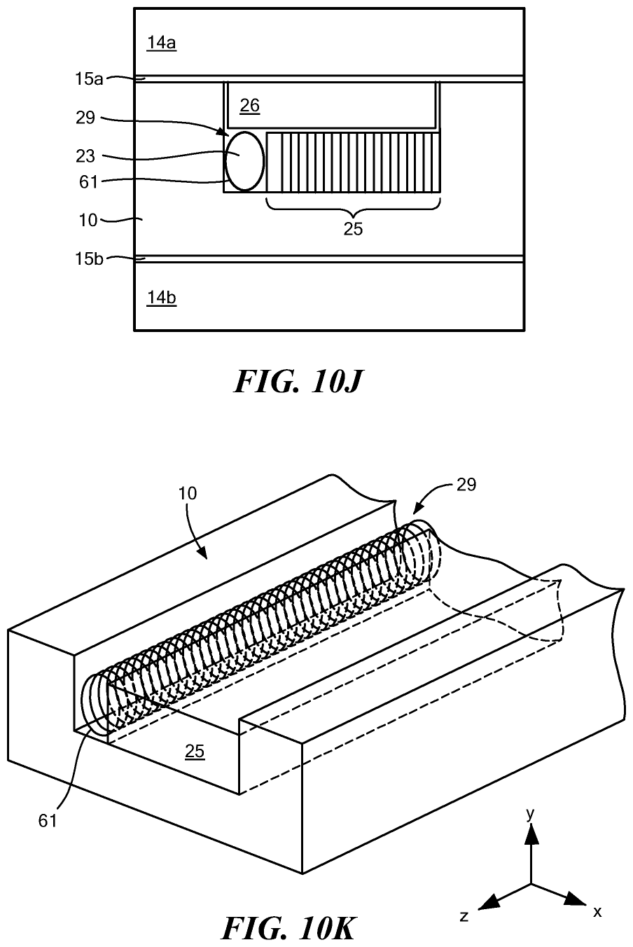

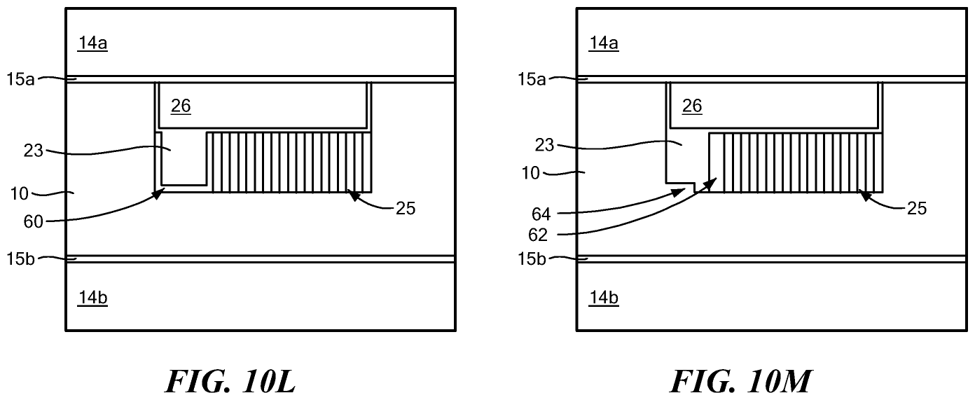

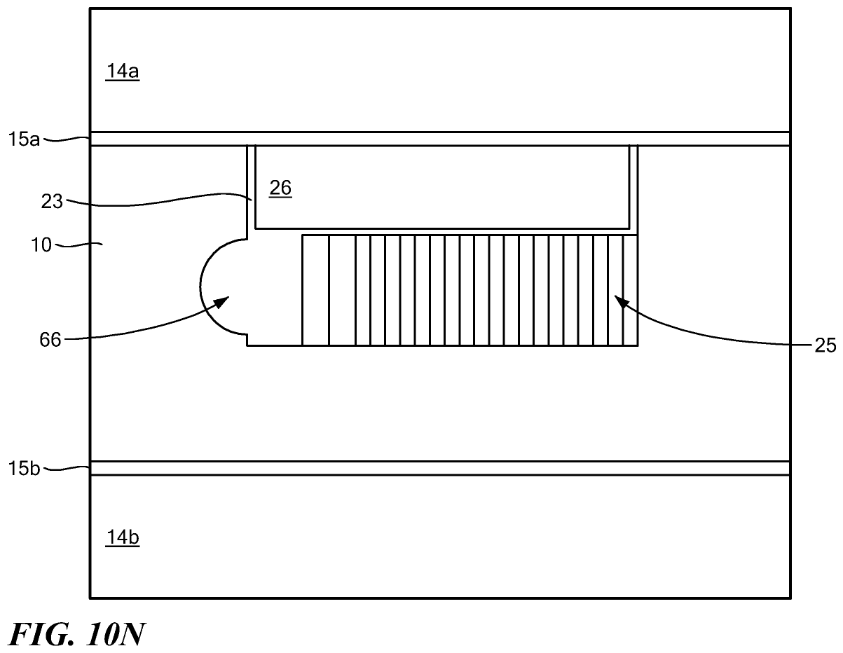

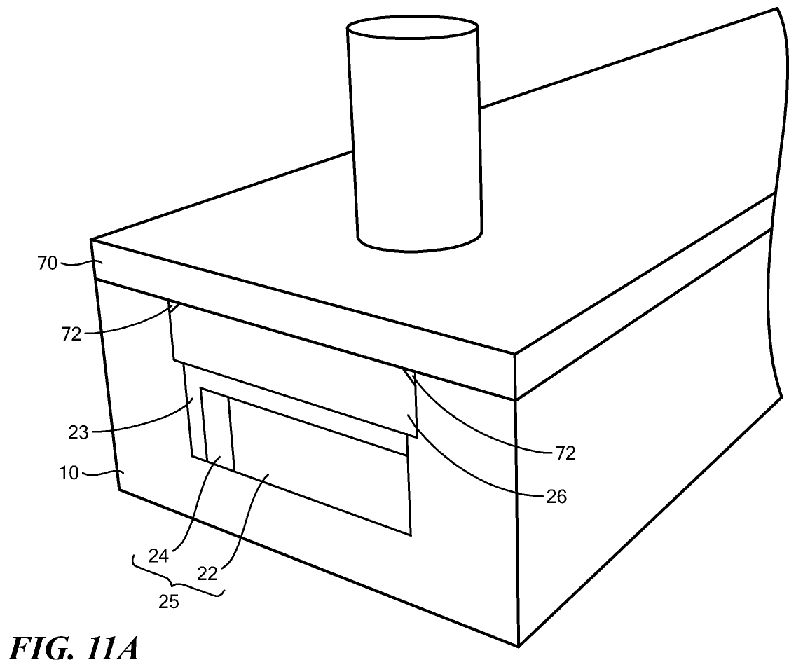

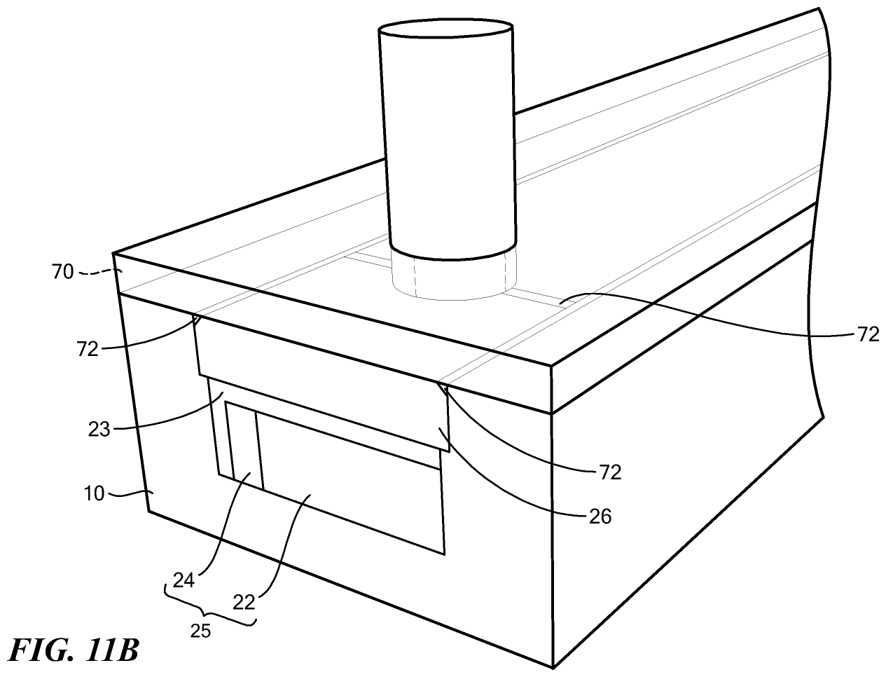

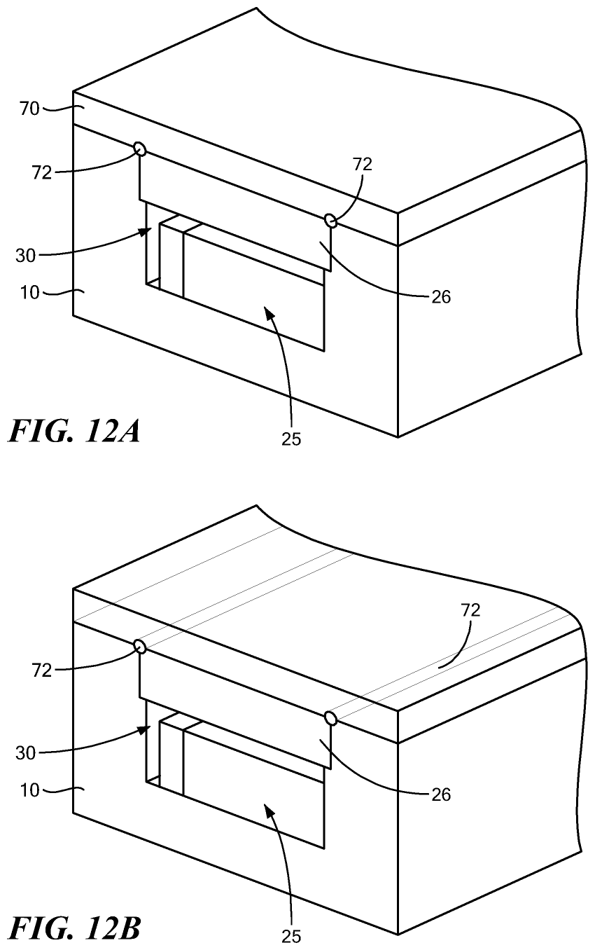

FIGS. 10A-10G illustrate alternative unit cell arrangements for a solder channels and channel caps.

FIGS. 10A-10C illustrate arrangements where the flow channel is above the tape stack. There may be a channel cap above (FIG. 10A) or below (FIG. 10C) the stack, or there may not be a cap needed (10B).

FIG. 10D shows an arrangement with a dedicated solder flow channel 29 integrated into the channel cap 26. As discussed, a channel cap having a solder flow channel has advantages in providing a larger hydraulic diameter and reduced chance (or in some designs no possibility), of the flow channel being blocked.

FIGS. 10E-10G show arrangements with a flow channel 29 built into the upper compression plate 14a. In this case, a gasket above the channel may be omitted, and the plate material may be one which does not bond to the solder to allow removal.

FIGS. 10H-10N show arrangements with side flow channels (or more simply “side channels”) in addition to or in place of a solder flow channel provided in a channel cap).

FIG. 10H shows a configuration with a flow channel 29 on the side of the HTS tape and co-wind. In the VPI flow process described herein, a molten metal (e.g., solder 23) flows in the side channel 29 and the HTS channel. In this case some means of maintaining the channel open is needed. In the case where the HTS tape is disposed in a channel having a spiral configuration, the means of maintaining the channel open may be provided by the tape winding tension.

Alternately, one or more spring-clips 60 or other structures can be inserted in the solder channel, as shown in FIG. 10I, to ensure that an open channel is maintained.

Alternatively, as shown in FIGS. 10J, 10K one or more coil springs 61 (i.e., a helical-shaped mechanical device that is close-wound or open-wound), may be inserted or otherwise disposed in the solder channel 29. The one or more coil springs may be provided having a size and shape selected to provide lateral spring force (i.e., force in +/−X direction in the coordinate system in FIG. 10K) sufficient to ensure that an open channel is maintained during a VPI process such that solder (or other molten metal) flows from the region inside the coil 61 to the region outside the coil. For example, the winding pitch of the spring (i.e., the distance from the center of one coil in the spring to the center of an adjacent coil in the spring—also sometimes referred to simply as pitch) can be made longer or shorter (e.g., multiple diameters) to suit the needs of a particular application.

FIGS. 10L-10N show embodiments of side flow channel geometries and placements of electrically and thermally conductive structures that prevent blockage due to movement of the tape stack.

FIG. 10L comprises a U-shaped structure 60 provided from an electrically and thermally conductive material (e.g., a co-wind material such as a copper co-wind material) disposed between co-wound HTS tapes 25 and a wall of a channel provided in plate 10.

FIG. 10M comprises an electrically and thermally conductive structure 62 (e.g., a co-wind material such as a copper co-wind material) and a detent 64 provided in the channel in which co-wound HTS tapes 25 are disposed.

In the example embodiment of FIG. 10N, the channel in which co-wound HTS tapes 25 are disposed comprises an extended region 66 (a side flow channel). Side flow channel 66 increases the hydraulic diameter and thus reduces the chance (or in some designs eliminates the chance) of the flow channel for a molten metal being blocked.

FIGS. 11A, 11B illustrate a solder flow configuration which allows solder to wet edges of a channel cap to walls defining a baseplate channel during a VPI process. FIG. 11A has the top rubber gasket 70 while in FIG. 11B the gasket is transparent. Thus, FIGS. 11A, 11B illustrate a concept whereby channels are formed or otherwise provided so that a VPI solder flow process flows solder in both the HTS channel (i.e., solder 23) and the edges of the copper cap (i.e., solder 72) in one step.

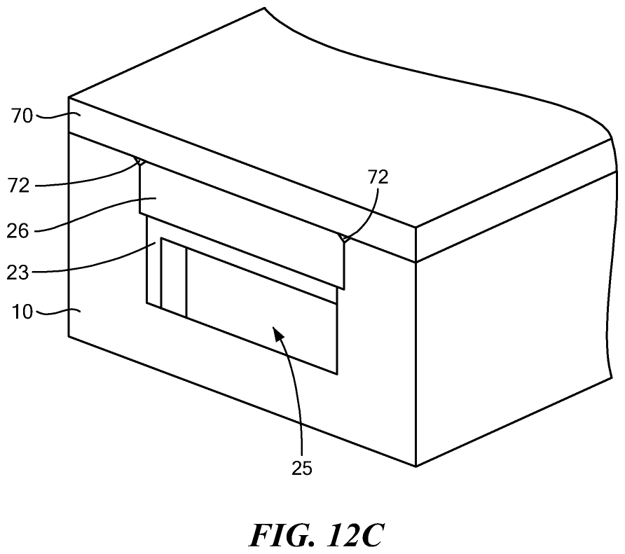

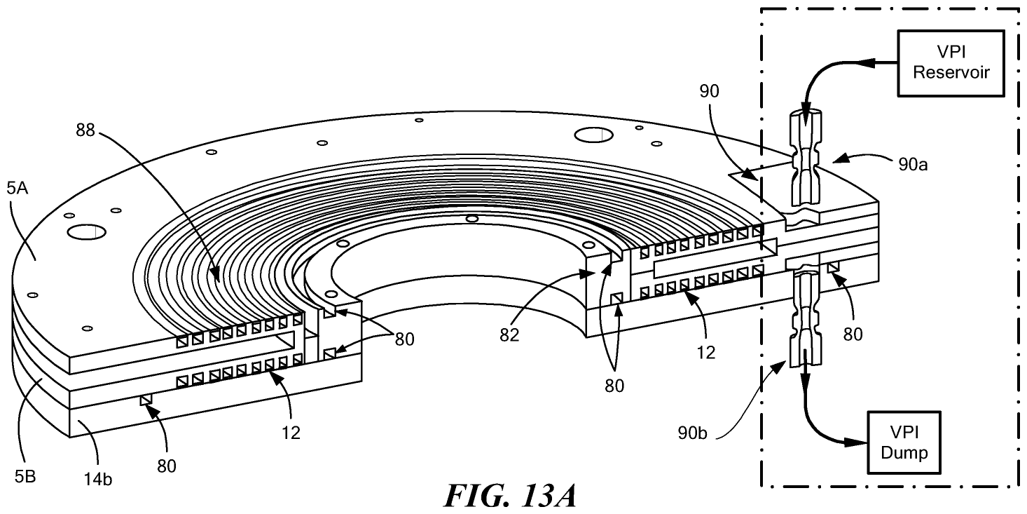

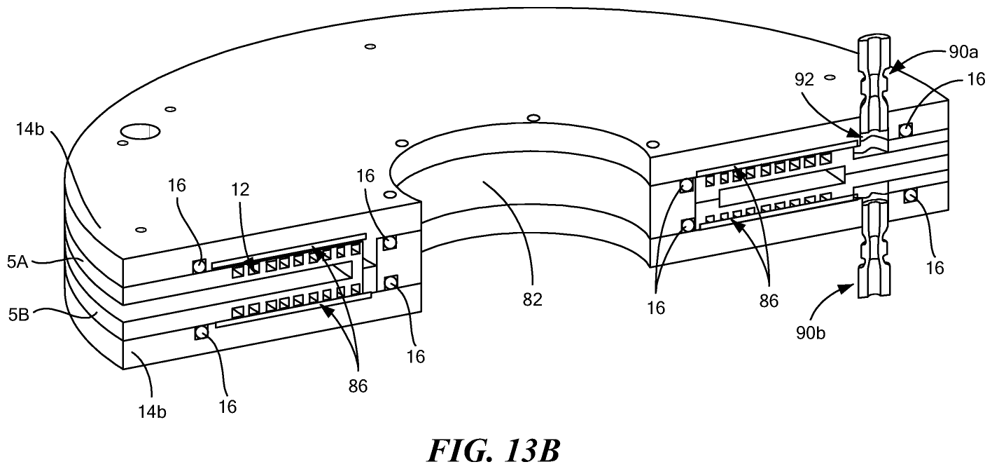

FIGS. 12A-12C are three figures which illustrate a sequence of a solder bar technique to couple a channel cap to walls defining a baseplate channel. In this technique, prior to assembling and heating the VPI plate assembly and flowing the VPI solder in an HTS channel, solder bars are placed on the edges of the copper cap. FIGS. 12A, 12B show the solder bars prior heating and VPI solder flow (in FIG. 13B the top plate is transparent). Solder paste may be used instead of or in combination with solder bars; the combination has been found to be highly effective since the paste holds the bars in place during assembly. FIG. 12C shows the end result after heating the solder bars and VPI solder flow through channels of a baseplate. Thus, the technique of FIGS. 12A-12C requires both a solder bar melting process and VPI solder flow process.

FIGS. 13A, 13B illustrate an example double pancake having HTS channels filled with metal. In this example embodiment, HTS channels 12 (or grooves) were machined to allow for 0.5 mm clearance between a copper cover and an HTS stack for solder flow. This example embodiment utilizes four (4) 0-rings 16 (FIG. 13B) disposed in grooves 80 and a containment cylinder 82. A small volume 84 between the cylinder and transitions will fill with molten metal (e.g., solder) and be contained by seals 86 which may, for example, be provided as silicone rubber seals 86. In this embodiment, the silicone rubber seals are provided by a silicone rubber sheet which presses a conductive (e.g., copper) spiral cover 88 in place and seals against HTS tape stacks (not shown in FIGS. 13A, 13B) disposed in channels 12.

This embodiment also includes an inlet/outlet manifold 90 sealed to the plates via a seal 92 with the Inlet 90a coupled to a solder reservoir (sometimes referred to as a “VPI reservoir”) such as the solder can in FIG. 8 and the outlet coupled to a solder dump (sometimes referred to as a “VPI dump”). The manifold directs solder flow into and out of the channel(s) in the plate(s). A seal 92 is disposed between base plates 5a, 5b and containment plates 14a, 14b to direct solder flow into the grooves.

FIG. 14 illustrates a plate having multiple inlets and multiple outlets. In this example, the inlets are in parallel and the outlets are in parallel. In other embodiments, the inlets and outlets may or may not be parallel. The desired flow path for the solder is indicated by arrows designated by reference numeral 93. The flow restriction (which may, for example, be provided as a felt metal material or solid metal material) seeks to reduce (or minimize or block) the flow from going in the direction of arrow designated by reference numeral 95, which is not desired.

FIG. 15A illustrates a plate having a single input and a single output while FIG. 15B illustrates an embodiment having a single input and a pair of outputs.

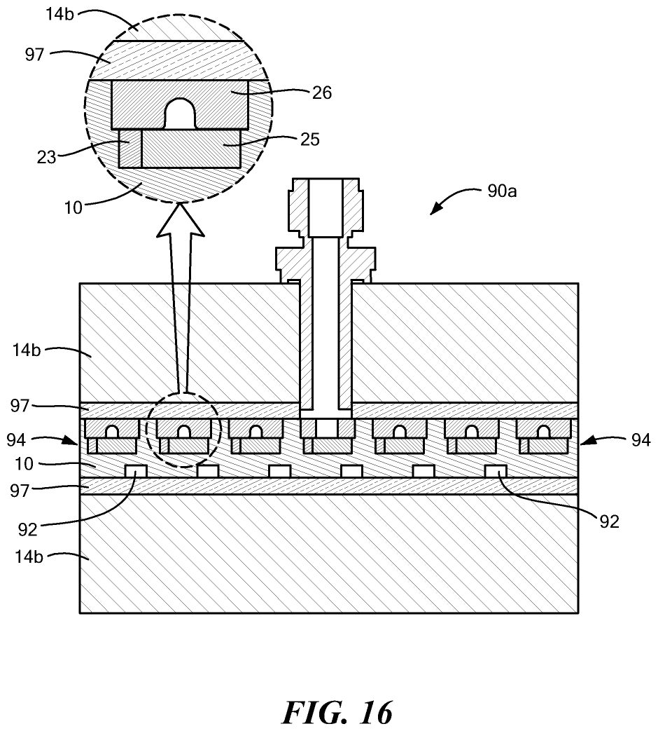

FIG. 16 is a cross-sectional view of a solder flow inlet. Shown is a solder injector fitting comprising a sleeve that guides solder below gasket material 97. This approach reduces (and ideally minimizes or eliminates) risk that the gasket moves and blocks the flow. Additionally, solder cap 26 comprises an opening which allows solder to enter into the solder channel 29 in the solder cap 26.

In embodiments, a VPI soldered channel concept includes a loose-fitting channel cap. (e.g., a conductive cap which ‘floats’ above HTS material disposed in a channel of a baseplate and is able to freely move vertically). It can actually have positive or negative buoyancy in solder depending on relative densities of cap and solder. In embodiments the channel cap may be provided from copper or any suitable electrically conductive material or may be provided from a material (either an electrically conductive material or a dielectric material having a conductive material disposed thereover (e.g., via plating or other techniques). There is no need to maintain a precise gap or spacing between the channel cap and a channel sidewall of for solder wicking. This results in a groove geometry which is simple to produce compared with other approaches described previously and also results in a structure which may be manufactured with mechanical tolerances (e.g. depth and width tolerances of channels in which HTS is disposed) which are greater than mechanical tolerances required in other approaches.

In embodiments, one may employ a cap provided from a ⅛″ thick copper plate. In embodiments, an HTS stack may be disposed beside a solder channel with dimensions 3 mm×4 mm. In the channel cap technique, a simple groove in the baseplate may be used (e.g., the groove need not have any steps or other mechanical features in sidewalls thereof). The channel cap is disposed over the HTS and ‘floats’ above HTS stack during a VPI soldering operation. This technique may require less machining than other techniques (and ideally requires minimal machining). Also, using the floating channel cap technique, all solder may be supplied by VPI—no solder bars or paste is needed. In embodiments, the floating copper acts as a ‘piston’—partially accommodating solder shrinkage and has the potential to reduce solder voids. In embodiments, a co-wind may be added as needed turn-by-turn. In embodiments a relatively large conductive cross-sectional area (e.g., ˜45 mm²) may be obtained. In embodiments, the conductive channel cap may be provided having a thickness which may result in a ‘bridge’ structure over a coolant channel having a thickness which results in a relatively strong radial plate (i.e., a trade-off may be made between a channel cap thickness and the thickness of a ‘bridge’ structure over a coolant channel. The floating channel cap approach with flow channel beside the HTS also allows for more space for winding HTS (including room to accommodate winding tools).

In summary, in one aspect, described is the use of one or more compression plates with gaskets to convert open NINT channels into a vacuum sealed assembly, with a single flow path. This enables a monotonic pressure gradient along the tape channel suitable for a VPI solder-filling process.

Also described is the use of one or more compression plates with gaskets to convert open NINT channels into a vacuum sealed assembly, with one or more inputs and/or one or more outlets thereby establishing one or multiple flow paths. Also described is vacuum-gas apparatus capable of independently controlling and stopping flow to either of multiple outlets in a VPI plate assembly. This approach gives flexibility to improve and ideally optimize a solder flow process depending upon channel length and/or to reduce solder flow time (i.e. the time required to flow solder through channels in a baseplate). In embodiments, a system utilizing a single inlet and a pair of outlets (thereby halving the flow path) reduces flow time by about a factor of three over solder fill systems having only a single inlet and a single outlet.

Also described is a channel cap having a channel specifically for solder flow (i.e. a channel cap comprising a solder channel). In embodiments, the solder channel in the cap is straight and may be centered. In embodiments, the solder channel in the cap is not straight and centered, but rather meanders from side to side (e.g. in an elongate S-shape) thus preventing HTS tapes from blocking the flow of solder in the baseplate channel. The channel cap also has detent features which prevent compression of the gap for solder flow.

Also described is a time-temperature process for VPI filling of open channels in a baseplate which includes intermediate heating a VPI plate assembly to a temperature below a metal flow temperature (which in some embodiments is a temperature of about 193° C.). Such intermediate heating may also be useful for VPI filling of closed-channel cables and in particular, may also be useful for VPI filling of large coils having a relatively high thermal mass and longer heating times.

Also described is an evaporative cooling system which applies a cooling liquid to compression and/or baseplates to rapidly cool such plates after flowing solder in baseplate channels, thereby reducing (and ideally minimizing) the time and temperature to which HTS tapes are exposed.

The described structures and techniques enable the filling of open HTS channels (i.e., open channels in a baseplate with having HTS disposed in the channels) with metal (e.g., solder). In embodiments, the channels in the baseplate may be in a spiral shape (e.g., in a so-called “racetrack” configuration). Such metal-filled open HTS channels find use in NINT magnets. The described metal filling structures and techniques described herein also enable the metal filling of linear HTS channels. Thus, the described structures and techniques are readily adaptable to different sizes and/or geometries of channels including but not limited to linear channels, curved channels, spiral channels, and other channel shapes.

The described structures and techniques used in VPI solder-filling approach result in solder-filled channels with the solder having desirable solder qualities (e.g., low void fraction, low resistance). It has been demonstrated up to scales of 89 meter channels while also resulting in degradation of HTS material characteristics of at most a few percent, at this scale. Solder quality of magnet coils with filled with this technique has been presently demonstrated to withstand Lorenz force body loads on the HTS stack of 800 kN/m. The structures and techniques in this process can readily be extended to even longer channels.

As used herein, a “high temperature superconductor” or “HTS” refers to a material having a critical temperature above 30° K, wherein the critical temperature refers to the temperature below which the electrical resistivity of the material drops to zero.

As used herein, an HTS “tape” may refer to any structure that includes a layer of an HTS, such as a rare-earth cuprate HTS (e.g., REBCO), and which may also contain one or more other layers such as one or more buffer layers, stabilizing layers, substrates, overlay layers and/or cladding layers. In some embodiments, an HTS tape may have an aspect ratio (being the ratio of the tape's width to its thickness) that is greater than or equal to 10, 20, 40, 60, 80, 100, 120 or 150. In some embodiments, the HTS tape may have an aspect ratio that is less than or equal to 150, 120, 100, 80, 60, 40, 20 or 10. Any suitable combinations of the above-referenced ranges are also possible (e.g., an aspect ratio of greater than or equal to 60 and less than or equal to 100). In some embodiments, an HTS tape may have a thickness greater than or equal to 0.01 mm, 0.05 mm, 0.1 mm, 0.15 mm, or 0.2 mm. In some embodiments, the HTS tape may have a thickness less than or equal to 0.5 mm, 0.2 mm, 0.15 mm, 0.1 mm, or 0.05 mm. Any suitable combinations of the above-referenced ranges are also possible (e.g., a thickness of greater than or equal to 0.05 mm and less than or equal to 0.2 mm). In some embodiments, an HTS tape may have a length greater than or equal to 25 m, 50 m, 100 m, 150 m, 200 m, 300 m or 500 m. In some embodiments, the HTS tape may have a length less than or equal to 1000 m, 500 m, 300 m, 200 m, 150 m, 100 m, or 50 m. Any suitable combinations of the above-referenced ranges are also possible (e.g., a length of greater than or equal to 100 m and less than or equal to 500 m).

Illustrative examples of channel caps having solder channels and the use of compression plates are described herein and illustrated in the drawings. It will be appreciated that the particular size and shape of the channel caps, solder channels in the channel cap and the particular size and shape of the compression and baseplate (as well as the particular size, shape and location of channels, inlets and outlets provided therein) are provided merely as examples and that no particular cross-sectional shape or size is implied as being necessary or desirable unless otherwise noted.

Having thus described several aspects of at least one embodiment which illustrate the described concepts, it is to be appreciated that various alterations, modifications, and improvements will readily occur to those skilled in the art.

Such alterations, modifications, and improvements are intended to be part of this disclosure, and are intended to be within the spirit and scope of the concepts described herein. Further, though advantages of the concepts described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the concepts described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts described herein may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A no-insulation, no-twist (NINT) magnet comprising:
a baseplate having a channel provided in a surface thereof;
a channel cap disposed over the channel;
one or more high temperature superconducting (HTS) tapes disposed in at least a portion of the open channel in the baseplate; and
a metal disposed in the baseplate channel and surrounding the one or more HTS tapes disposed in the channel.

2. The NINT magnet of claim 1 wherein the channel cap has a solder channel provided in a surface thereof.

3. The NINT magnet of claim 2 wherein the solder channel of the channel cap has a meandering shape.

4. The NINT magnet of claim 2 wherein the baseplate has a solder channel having a meandering shape provided in the channel of the baseplate.

5. The NINT magnet of claim 3 or both wherein a period of the meandering channel is selected such that each section of the one or more HTS tapes is restrained at a plurality of points sufficient to prevent the one or more HTS tapes from substantially rising into the channel of the baseplate.

6. The NINT magnet of claim 1 wherein the channel cap has a segmented solder channel provided in a surface thereof.

7. The NINT magnet of claim 6 wherein the segmented solder channel is formed by a plurality of members projecting from sidewalls of the solder channel.

8. The NINT magnet of claim 6 wherein the segmented solder channel has a gap of substantially uniform width across the full tape channel and spacers are disposed in the channel and configured to keep the cap raised above the one or more HTS tapes, while still allowing solder to flow in the channel.

9. The NINT magnet of claim 1 wherein the baseplate has one or more metal inputs and/or one or more metal outputs.

10. The NINT magnet of claim 1 further comprising one or more spring-clips disposed in the channel of the baseplate.

11. The NINT magnet of claim 1 further comprising one or coil springs disposed in the channel of the baseplate.

12. The NINT magnet of claim 1 further comprising a co-wind material disposed in the channel proximate the one or more HTS tapes with the co-wind material having a size and shape selected such that a solder flow path is not obstructed by placement of the one or more HTS tapes in the channel.

13. The NINT magnet of claim 1 wherein the channel in the baseplate further comprises a side flow channel which provides a flow path for solder.

14. A channel cap configured to be arranged in a channel of a baseplate, the channel cap comprising a solder channel for solder flow.

15. The channel cap of claim 14 wherein the solder channel is straight and at least portions of the solder channel are located along a centerline of the channel.

16. The channel cap of claim 14 wherein the solder channel is straight and at least portions of the solder channel are offset from a centerline of the channel.

17. The channel cap of claim 14 wherein the solder channel has a meander shape.

18. A channel cap configured to be arranged in a channel of a baseplate, the channel cap comprising a solder channel having one or more segmentation structures disposed in the channel cap solder channel, wherein the segmentation structures are configured to direct the flow of solder within the channel.

19. The channel cap of claim 18 wherein the solder channel is straight and at least portions of the solder channel are located along a centerline of the channel.

20. The channel cap of claim 18 wherein the solder channel is straight and at least portions of the solder channel are offset from a centerline of the channel.

21. The channel cap of claim 18 wherein the solder channel has a meandering shape.

22. A magnet comprising:
a coil comprising a plurality of non-insulated windings, the windings comprising:
a stack of high temperature superconductor (HTS) tapes, wherein each of the HTS tapes comprises an HTS material;
a co-conductor layer arranged over the stack of HTS tapes;
one or more spacer structures; and
a region of solder arranged in contact with the stack of HTS tapes, the co-conductor layer, and the one or more spacer structures.

23. The magnet of claim 22, wherein the plurality of windings are wound around an axis aligned in a first direction, and wherein the HTS tapes of the stack of HTS tapes are stacked radially with respect to the axis.

24. The magnet of claim 23, wherein the co-conductor layer is arranged over the stack of HTS tapes along the first direction.

25. The magnet of claim 22, wherein the solder comprises a metal having a melting point of less than 200° C., wherein at least 50 wt % of the metal is lead (Pb) and/or tin (Sn).

26. The magnet of claim 22, wherein the one or more spacer structures are integrally formed with the co-conductor layer.

27. The magnet of claim 22, wherein the one or more spacer structures include one or more spacers arranged along sides of the winding and contacting sides of the HTS tapes.

28. The magnet of claim 22, wherein the one or more spacer structures include a plurality of spacer structures arranged between the co-conductor layer and the stack of HTS tapes.

29. The magnet of claim 22, wherein the one or more spacer structures comprise one or more springs.

30. The magnet of claim 22, wherein the windings comprise solder arranged between the stack of HTS tapes and the co-conductor layer, and alongside the one or more spacer structures.

31. The magnet of claim 22, wherein the magnet comprises a baseplate having a channel formed therein, and wherein the plurality of windings are arranged within the channel of the baseplate.

32. The magnet of claim 22, wherein the one or more spacer structures are arranged in contact with the stack of HTS tapes.

33. A magnet comprising:
a coil comprising a plurality of non-insulated windings, the windings comprising:
a stack of high temperature superconductor (HTS) tapes, wherein each of the HTS tapes comprises an HTS material;
a co-conductor layer comprising a solder channel that meanders across a width of the windings; and
solder arranged within the solder channel.

34. The magnet of claim 33, wherein the solder channel is arranged within a surface of the co-conductor layer that contacts the stack of HTS tapes, and wherein the solder is in contact with the stack of HTS tapes.

35. The magnet of claim 33 wherein the solder channel has a sinusoidal shape.

36. The magnet of claim 33, wherein the plurality of windings are wound around an axis aligned in a first direction, and wherein the HTS tapes of the stack of HTS tapes are stacked radially with respect to the axis.

37. The magnet of claim 33, wherein the co-conductor layer is arranged over the stack of HTS tapes along the first direction.

38. The magnet of claim 33, wherein the solder comprises a metal having a melting point of less than 200° C., wherein at least 50 wt % of the metal is lead (Pb) and/or tin (Sn.

39. A method of forming a no-insulation, no-twist (NINT) high temperature superconducting (HTS) magnet, the method comprising:
arranging an HTS material in an open HTS channel of a baseplate;
covering the open HTS channel to form a closed HTS channel; sealing the channel using a gasket, o-ring or other compressive seal to allow pressurization and/or pumping of the channel and
at least partially filling the HTS channel with a molten metal.

40. The method of claim 39 wherein covering the open HTS channel to form a closed HTS channel comprises arranging a channel cap comprising a solder flow channel over the open HTS channel of the baseplate to form the closed channel.

41. The method of claim 39 further comprising:
heating the baseplate; and
wherein at least partially filling the HTS channel with a molten metal comprises applying pressure to a molten metal so as to force the molten metal through the closed HTS channel.

42. The method of claim 40, wherein the molten metal is held in a container, and wherein applying pressure to the molten metal comprises applying pressure to the molten metal within the container.

43. The method of claim 39 wherein pressure is reduced in one end of the channel to draw molten solder into open spaces within the channel.
